(19) United States
(12) Patent Application Publication
(10) Pub. No.: US 2026/0187856 A1
(43) Pub. Date: Jul. 2, 2026

(54) FACIAL EXPRESSION INFORMATION GENERATION METHOD, EMOTION RECOGNITION METHOD, AND MODEL TRAINING METHOD, AND APPARATUSES THEREFOR

(71) Applicant: MASHANG CONSUMER FINANCE CO., LTD., Chongqing (CN)

(72) Inventors: Chun WANG, Chongqing (CN); Weihong DENG, Chongqing (CN)

(21) Appl. No.: 19/265,361

(22) Filed: Jul. 10, 2025

(30) Foreign Application Priority Data
Dec. 28, 2024 (CN) 202411978658.X

(51) Int. Cl. G06T 11/00; G06F 40/35; G06V 10/74; G06V 10/774; G06V 10/776; G06V 40/16

(52) U.S. Cl. CPC G06T 11/00; G06V 10/761; G06V 10/774; G06V 10/776; G06V 40/174; G06F 40/35; G06T 2200/24

(57) ABSTRACT

Facial expression generation method, emotion recognition method and model training method, and apparatuses therefor are provided. Facial expression generation method includes that: a first parameter value for representing an intensity of a first emotion is received; and first facial expression information adapted to the first parameter value of a first basic emotion is displayed when the first emotion is the first basic emotion.

### CROSS-REFERENCE TO RELATED APPLICATIONS

This application claims priority to Chinese Patent Application No. 202411978658.X, filed on Dec. 28, 2024, the entire content of which is incorporated herein by reference in its entirety.

### BACKGROUND

In recent years, with the development of computer technology and artificial intelligence technology, as well as the increasing demand of users for computer functionality, the functions of computers are gradually enriched. For example, in the field of facial expression information processing, corresponding facial expression information may be generated by a computer based on a specified condition, or corresponding emotional information may be obtained by recognizing an expression image by a computer.

However, current technical solutions for condition-controllable facial expression information generation and technical solutions for emotion recognition based on expression image have the problem of insufficient refinement in the emotional indicators. This makes it difficult to meet the refined application demands of adjusting a facial image expression based on real emotional constraints, and performing an emotion recognition based on the expression image.

### SUMMARY

The disclosure relates to the technical field of artificial intelligence, and in particular to a method and apparatus for generating facial expression information, a method and apparatus for recognizing an emotion, and a method and apparatus for training a model.

In a first aspect, an embodiment of the disclosure provides a method for generating facial expression information, and the method includes the following operations.

A first parameter value of a first emotion is received. The first parameter value is used to represent an intensity of the first emotion.

When the first emotion is a first basic emotion, first facial expression information adapted to the first parameter value of the first basic emotion is displayed.

In a second aspect, an embodiment of the disclosure provides a method for recognizing an emotion, and the method includes the following operations.

A second facial expression image is acquired.

A second emotion adapted to the second facial expression image and a third parameter value of the second emotion are displayed. When the second emotion is a third basic emotion, the third parameter value is used to represent an intensity of the third basic emotion.

In a third aspect, an embodiment of the disclosure provides a method for training a model, and the method includes the following operations.

A first training set is created. The first training set includes fourth feature dimension data and a fourth parameter value of a fourth basic emotion, the fourth feature dimension data has a correlation with a facial expression, and the fourth parameter value is used to represent an intensity of the fourth basic emotion.

A first sub-model of a first model is trained with the fourth feature dimension data and the fourth parameter value of the fourth basic emotion.

### BRIEF DESCRIPTION OF THE DRAWINGS

In order to explain the technical solutions in embodiments of the disclosure or the Background more clearly, the drawings used in the embodiments of the disclosure or the Background will be illustrated in the following.

FIG. 1 is a schematic diagram of architecture of an expression information processing system according to an embodiment of the disclosure.

FIG. 2A is a flowchart of a method for generating facial expression information according to an embodiment of the disclosure.

FIG. 2B is a processing flowchart of generating first facial expression information based on random sampling and a first parameter value according to an embodiment of the disclosure.

FIG. 2C is a processing flowchart of generating the first facial expression information based on original facial expression information and the first parameter value according to an embodiment of the disclosure.

FIG. 2D is a schematic diagram of a display interface of a dialogue large model system according to an embodiment of the disclosure.

FIG. 2E is another schematic diagram of the display interface of the dialogue large model system according to an embodiment of the disclosure.

FIG. 2F is yet another schematic diagram of the display interface of the dialogue large model system according to an embodiment of the disclosure.

FIG. 2G is a schematic diagram of a display interface of an artificial intelligence-generated content system according to an embodiment of the disclosure.

FIG. 2H is another schematic diagram of the display interface of the artificial intelligence-generated content system according to an embodiment of the disclosure.

FIG. 2I is a schematic diagram of a digital human interaction interface according to an embodiment of the disclosure.

FIG. 2J is a schematic diagram of a facial expression image displayed on a screen of a robot head according to an embodiment of the disclosure.

FIG. 2K is a schematic diagram of a facial expression action state of a simulated face on the robot head according to an embodiment of the disclosure.

FIG. 2L is another schematic diagram of the facial expression action state of the simulated face on the robot head according to an embodiment of the disclosure.

FIG. 3A is a flowchart of a method for recognizing an emotion according to an embodiment of the disclosure.

FIG. 3B is still yet another schematic diagram of the display interface of the dialogue large model system according to an embodiment of the disclosure.

FIG. 3C is a processing flowchart of generating a second emotion and a third parameter based on a second facial expression image according to an embodiment of the disclosure.

FIG. 4A is a flowchart of a method for training a model according to an embodiment of the disclosure.

FIG. 4B is a processing flowchart of generating multiple fourth disentangled representation vectors based on multiple second face images according to an embodiment of the disclosure.

FIG. 5A is a schematic structural diagram of an apparatus for generating facial expression information according to an embodiment of the disclosure.

FIG. 5B is another schematic structural diagram of the apparatus for generating the facial expression information according to an embodiment of the disclosure.

FIG. 6A is a schematic structural diagram of an apparatus for recognizing an emotion according to an embodiment of the disclosure.

FIG. 6B is another schematic structural diagram of the apparatus for recognizing the emotion according to an embodiment of the disclosure.

FIG. 7A is a schematic structural diagram of an apparatus for training a model according to an embodiment of the disclosure.

FIG. 7B is another schematic structural diagram of the apparatus for training the model according to an embodiment of the disclosure.

### DETAILED DESCRIPTION

In order to enable those skilled in the art to better understand the solutions of the disclosure, the technical solutions in the embodiments of the disclosure will be clearly and completely described below with reference to the accompanying drawings in the embodiments of the disclosure. It will be apparent that the described embodiments herein are only part of but not all of the embodiments in the disclosure. Based on the embodiments in the disclosure, all other embodiments obtained by those of ordinary skilled in the art without making any creative effort shall fall within the scope of protection of the disclosure.

The terms “first,” “second,” and “third” and the like in the description, the claims and the drawings of the disclosure are used to distinguish different objects, but not used to describe a particular order. Furthermore, the terms “comprise” and “have” and any variations thereof are intended to cover non-exclusive inclusions. For example, a process, a method, a system, a product, or an electronic device that includes a series of operations or units is not limited to the listed operations or units, but may optionally include operations or units that are not listed, or may optionally include other operations or units inherent to the process, the method, the system, the product, or the electronic device.

“embodiment” mentioned herein means that a particular feature, structure, or characteristic described in connection with the embodiment may be included in at least one embodiment of the disclosure. The occurrence of this phrase in various positions throughout the description does not necessarily refer to the same embodiment, nor is it an independent or alternative embodiment that is mutually exclusive from other embodiments. It is explicitly and implicitly understood by those skilled in the art that the embodiments described herein may be combined with other embodiments.

Some of the concepts involved in embodiments of the disclosure are explained below.

Basic emotion and compound emotion: in the fields of emotion science and computer vision, the basic emotions and the compound emotions are two key concepts that help us understand the complexity of human emotions and their reflection in facial expressions.

The basic emotion is a group of basic emotional types that are universally present in human society. These emotions are considered innate and are reflected in different cultures and societies. Psychologists usually regard emotions such as happiness, sadness, amazement, fear, disgust and anger as the basic emotion. These emotions are directly related to specific physiological responses and facial expressions, forming the foundation of human emotional communication.

The compound emotion is a more complex and delicate emotional state, and is formed by the combination of two or more basic emotions. For example, surprise can be regarded as a combination of amazement and happiness, while embarrassment may emerge from a mixture of amazement, sadness, and disgust. The compound emotions reflect the diversity and complexity of human emotional experiences, and are often related to more specific life situations and personal experiences.

The relationships between the basic emotions and the compound emotions reflect the progression of emotional experience from simplicity to complexity. The basic emotions are the cornerstones that constitute the compound emotions, while the compound emotions show interweaving and evolution of the basic emotions in complex social interactions and personal experiences. This framework from basic to compound not only facilitates our understanding of the hierarchical structure of human emotions, but also provides an effective way for computer vision systems to recognize and interpret human emotional states, and then plays an important role in fields such as human-computer interaction, emotional analysis.

The relationships between emotions and expressions: the relationships between emotions and expressions are both close and complex. But overall, the emotions are internal and the expressions are external. The emotions, such as happiness, sadness, and anger, are reflected externally as expressions (such as smiling or frowning) through the movement of facial muscles, thereby enabling us to express and communicate our inner state. However, these relationships are not a simple one-to-one correspondences. A compound emotion, such as joy with melancholy, leads to more diverse and subtle expression of expressions. A same emotion may be conveyed through different expressions, and a same expression may also represent different emotions, reflecting the complexity the relationships between the emotions and the expressions.

Action Units (AUs): the action units are the basic components in facial expression analysis, originating from the facial action coding system (FACS) developed by the psychologists Paul Ekman and W. V. Friesen. Each action unit represents a specific movement of the facial muscles, such as rising the eyebrows, rising the corners of the mouth. Various complex facial expressions may be precisely described and distinguished by combining different action units. The detailed division of the action units makes them an important tool for analyzing and recognizing human expressions in the fields of emotion research, human-computer interaction and computer vision.

Unsupervised disentangled representation learning: the unsupervised disentangled representation learning is a deep learning technique intended to automatically extract and separate intrinsic features or factors from unlabeled data. Through this method, model learns to represent data as a set of mutually independent dimensions, and each dimension corresponds to a basic factor in the data generation process, without relying on external annotation information. This not only enhances understanding and interpretability of the model on the data, but also improves its generalization capability on unseen data.

Invertible neural network (INN): the invertible neural network, through its unique design, realizes the capability to accurately reconstruct the input from the output. The core of the INN lies in its reversibility and maintenance of information integrity. This network ensures that no information is lost during the forward and backward propagation processes of the deep learning model, enabling them to have a better performance when handling tasks that require high information retention, such as image processing and data generation. In short, the main characteristic of the INN is that it can maintain the information integrity and ensure accurate reversible mapping between the input and the output during the complex data conversion process.

In the current technical solutions for condition-controllable facial expression information generation, the facial expression may only be generated based on the relationships between the preset action codes and the expressions, or the expression information of face image may be adjusted by transferring the expression of the existing reference image to another image. That is to say, at present, if one wants to adjust the expression of the face image based on preset emotional conditions, it can only be achieved by establishing a system of an emotional indicator based on the existing action codes or reference images. In the system of emotional indicator, the emotional indicators are discrete from each other, the granularities of these emotional indicator are relatively coarse, and the correspondences between the emotional indicators and the expression information is disordered. When adjusting the expression of the face image by changing the emotional conditions, it is impossible to finely present the changes in expressions under different emotional intensities. However, real human emotions are typically complex and diverse. Even the expression information corresponding to different emotional intensities of the same basic emotion has certain differences. Therefore, the emotional indicators used by the existing technical solutions for condition-controllable facial expression information generation lack sufficient refinement, making it difficult to meet the demands of users for refined applications in adjusting facial image expressions based on real emotional constraints. Correspondingly, when performing the emotion recognition based on the existing system of emotional indicator, the changes of emotional intensity cannot be recognized. That is to say, the low fineness level in emotion recognition cannot meet the demands of users.

In view of the above problems, embodiments of the disclosure provide a method and an apparatus for generating facial expression information, a method and an apparatus for recognizing an emotion, and a method and an apparatus for training a model, with the aim of improving the refinement and scenario applicability of the condition-controllable facial expression information function and the emotion recognition function, as well as improving the stability and accuracy of data processing when an electronic device operates the condition-controllable facial expression information function and the emotion recognition function. Hereinafter, detailed description will be made with reference to the drawings.

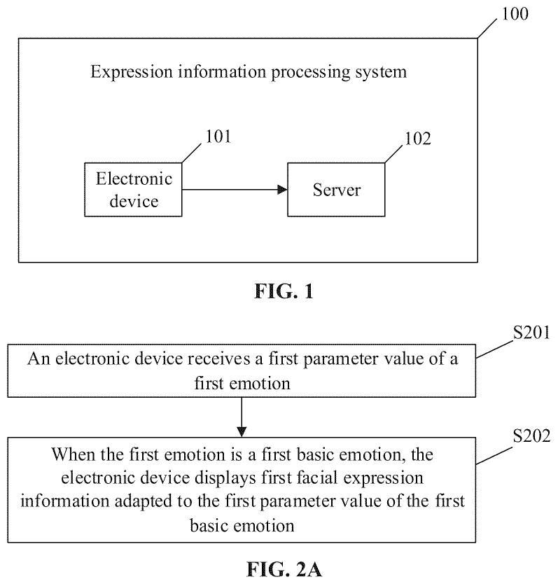

The method and apparatus for generating the facial expression information, the method and apparatus for recognizing the emotion, and the method and apparatus for training the model according to the embodiments of the disclosure may be applied to the expression information processing system as illustrated in FIG. 1. Referring to FIG. 1, it is a schematic diagram of architecture of the expression information processing system according to an embodiment of the disclosure. The expression information processing system 100 includes an electronic device 101 and a server 102, and the electronic device 101 may communicate with the server 102 through a network. The electronic device 101 refers to an electronic device used by a user, such as a smart phone, a computer, or a robot-controlled electronic device, and the like. In this solution, the electronic device 101 is mainly responsible for interacting with the user, so as to acquire a parameter value for representing the intensity of emotion or to acquire a facial expression image, and transmit the acquired data to the server 102 for processing. The electronic device 101 is also responsible for displaying facial expression information adapted to the parameter value from the server 102, or displaying a parameter value adapted to the facial expression image and representing the intensity of emotion from the server 102. The user may interact with the system 100 through the electronic device 101, performing voice input, gesture operation, expression image uploading operation, numerical adjustment operation for basic emotions, selection operation for a compound emotion selection control, and the like. The server 102 refers to a remote computer for processing a large number of computing tasks and storing data. In this solution, the server 102 is mainly responsible for receiving a parameter value representing the intensity of emotion from the electronic device 101, and returning facial expression information adapted to the parameter value to the electronic device 101. Alternatively, the server 102 is responsible for receiving a facial expression image from the electronic device 101, and returning a parameter value that is adapted to the facial expression image and represents the intensity of emotion to the electronic device 101. Alternatively, the server 102 is responsible for creating a first training set, and training a first sub-model with feature dimension data having a correlation with a facial expression in the first training set and parameter(s) for representing the intensity of basic emotion(s).

Of course, in other embodiments, the electronic device 101 and the server 102 may also be the same electronic device. That is to say, a single computer may interact with the user to acquire the parameter value for representing the intensity of emotion, and display the facial expression information adapted to the parameter value. Alternatively, the single computer may interact with the user to acquire the facial expression image, and display the parameter value that is adapted to the facial expression image and represents the intensity of emotion. Alternatively, the single computer may create the first training set and train the first sub-model.

Based on this, the disclosure provides the method and apparatus for generating facial expression information, the method and apparatus for recognizing an emotion, and the method and apparatus for training a model. Hereinafter, detailed description of the disclosure will be made with reference to the drawings.

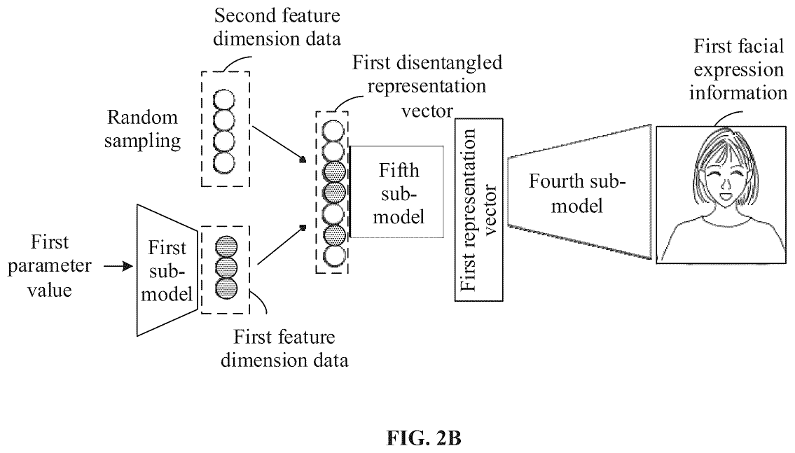

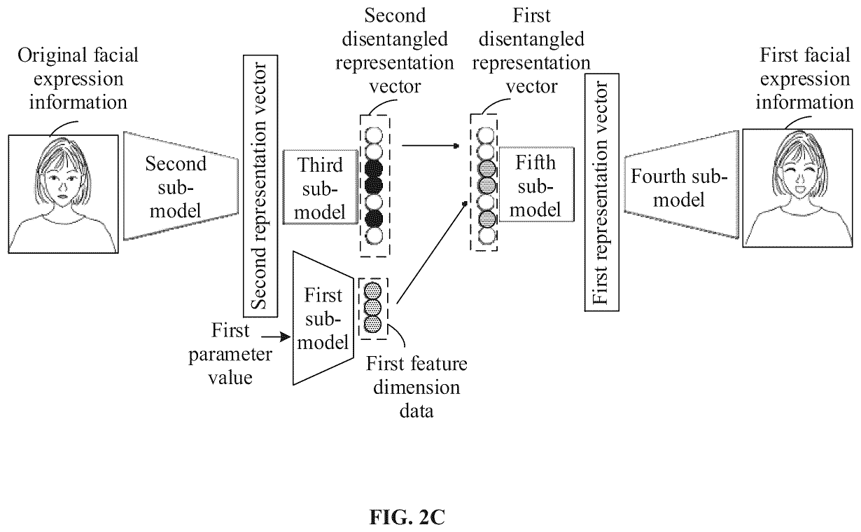

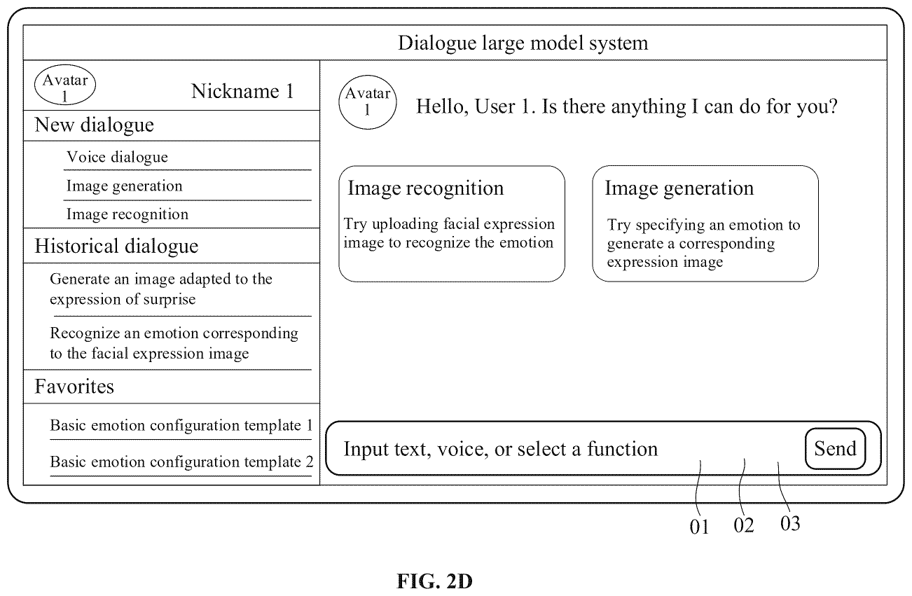

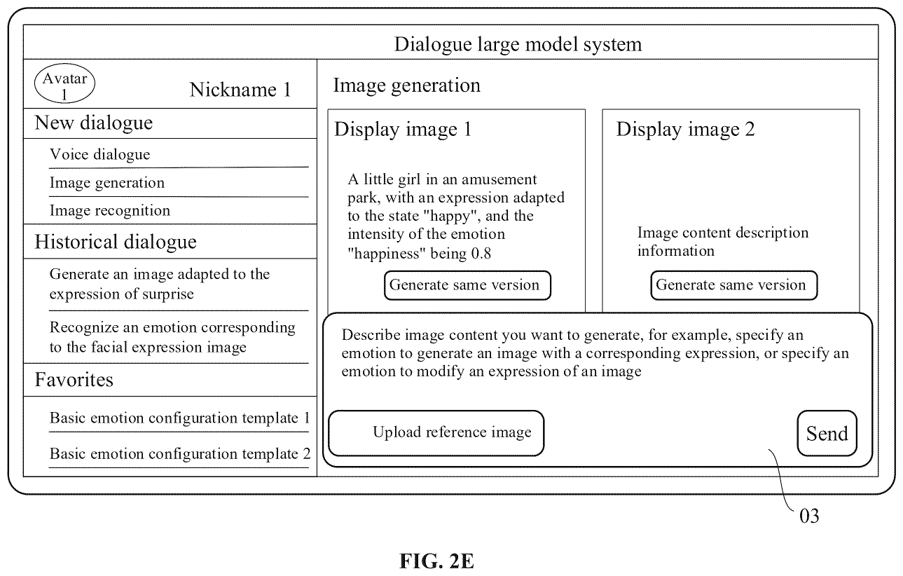

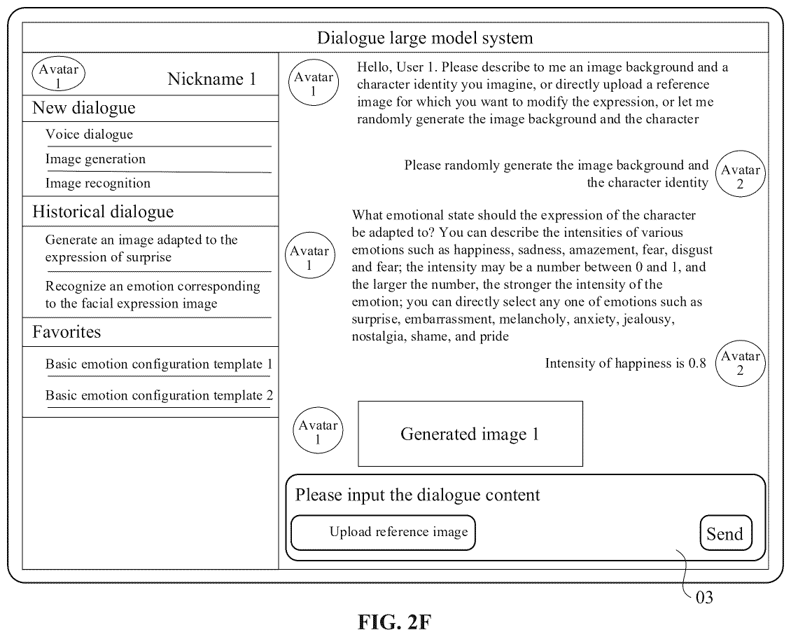

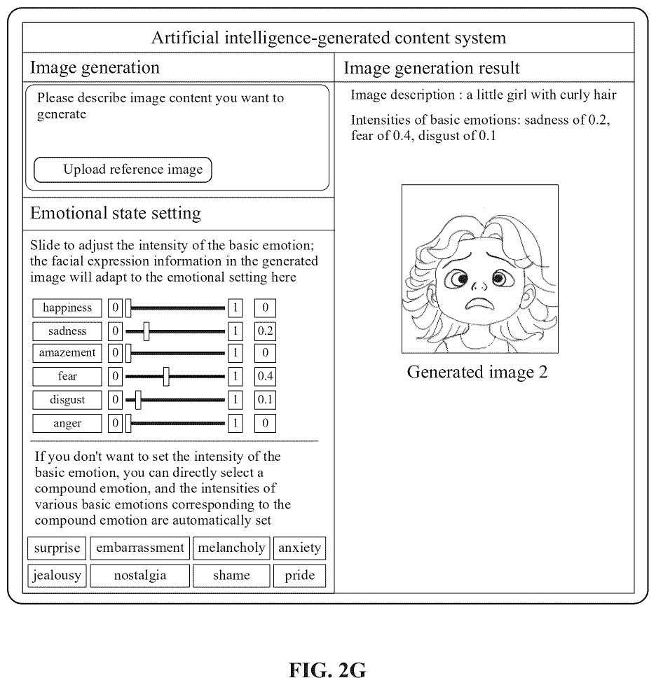

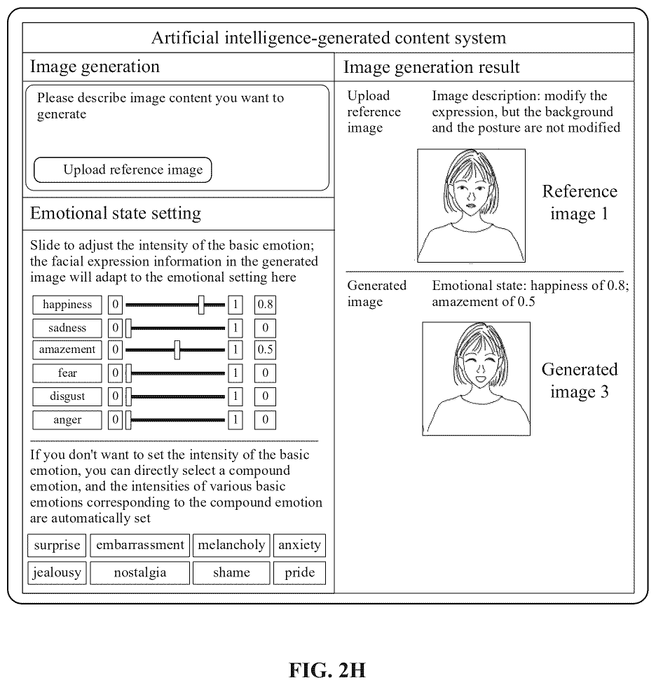

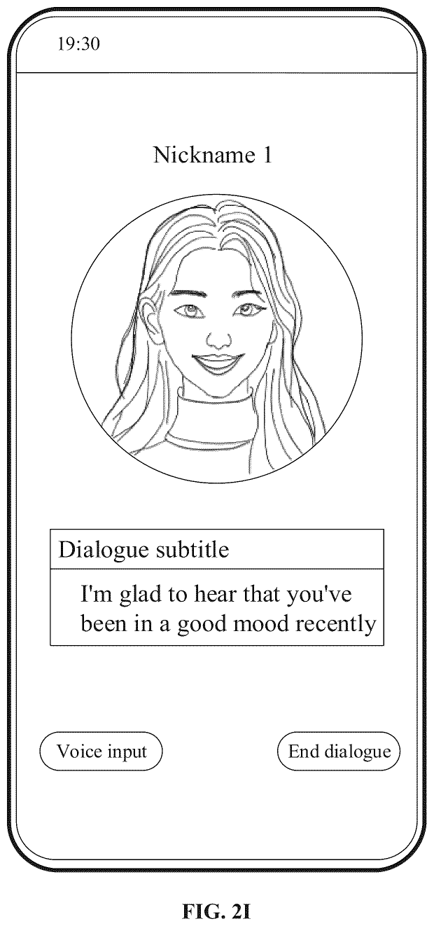

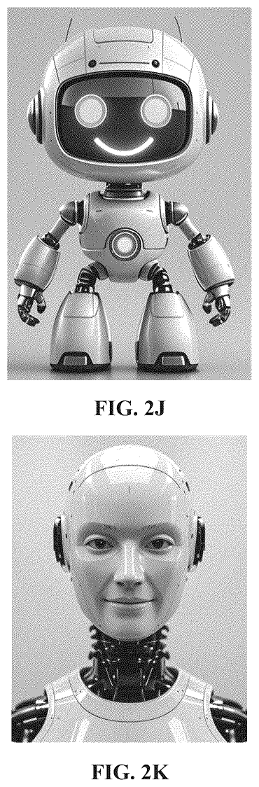

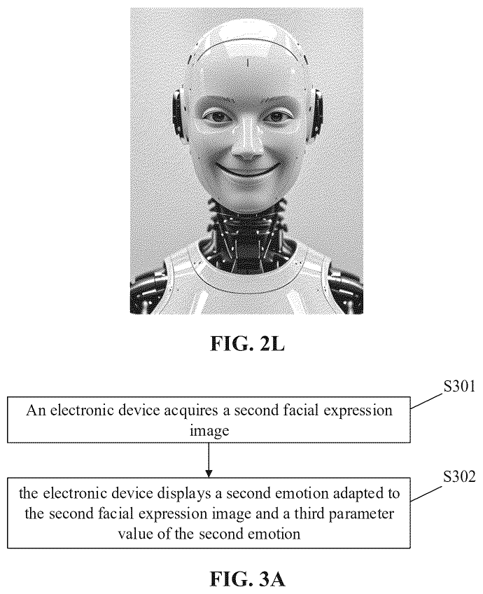

Referring to FIG. 2A, it is a flowchart of a method for generating facial expression information according to an embodiment of the disclosure. The method may be applied to the electronic device 101 as illustrated in FIG. 1, and as illustrated in FIG. 2A, the method includes the following operations.

In operation S201, an electronic device receives a first parameter value of a first emotion.

The first parameter value is used to represent an intensity of the first emotion.

In operation S202, the electronic device displays first facial expression information adapted to the first parameter value of a first basic emotion when the first emotion is the first basic emotion.

The specific representation form of the first facial expression information may be, for example, a facial expression image, a facial expression animation, a facial expression action state, or the like.

The basic emotion is an emotion type defined in the fields of emotion science and computer vision, and the first basic emotion may include, for example, at least one of: happiness, sadness, amazement, fear, disgust or anger.

The first parameter value is a unique parameter value within the intensity distribution range. Taking an example where the basic emotions include happiness, sadness, amazement, fear, disgust, and anger, and the intensity distribution range corresponding to each basic emotion is from 0 to 1, the first parameter value ranges from 0 to 1. Assuming that the first emotion includes the first basic emotion in a state of sadness, and the first parameter value corresponding to the state of sadness is 0.8, the displayed first facial expression information is facial expression information adapted to the emotion of sadness with an emotional intensity of 0.8. Taking another example where the first emotion includes the first basic emotions in a state of sadness and a state of fear, and a first parameter value corresponding to the state of sadness is 0.8 and a parameter value corresponding to the state of fear is 0.2, the displayed first facial expression information is facial expression information adapted to the emotion of sadness with an emotional intensity of 0.8 and the emotion of fear with an emotional intensity of 0.2.

In practical applications, the first emotion may be the first basic emotion or the first compound emotion. The compound emotion, as defined in the fields of emotion science and computer vision, is an emotional state resulting from the combined effects of at least two basic emotions. Specifically, the compound emotion may include any of the following emotional states: surprise (a combination of the basic emotions of amazement and happiness), embarrassment (a mixture of basic emotions of amazement, sadness, and disgust), melancholy, anxiety, jealousy, nostalgia, shame, and pride.

In a specific implementation, the mapping relationships between the compound emotions and the basic emotion configurations may be preset based on the basic emotion types included in the compound emotions described above, and then, when the first emotion is the first compound emotion, the electronic device may directly acquire a second basic emotion configuration corresponding to the first compound emotion based on the mapping relationships, as the first parameter value corresponding to the first compound emotion. Specifically, the second basic emotion configuration corresponding to the first compound emotion may include a second basic emotion corresponding to the first compound emotion and a second parameter value of the second basic emotion. When the first emotion is the first compound emotion, the first facial expression information adapted to the second parameter value of the second basic emotion corresponding to the first compound emotion may be displayed by querying the mapping relationships.

The second parameter value is also a unique parameter value within the intensity distribution range. For example, still taking an example where the intensity distribution range corresponding to each basic emotion is from 0 to 1, assuming that the first emotion includes the first compound emotion in a state of surprise, and it is determined based on mapping relationships that the second basic emotion configuration corresponding to the first compound emotion includes the emotion of happiness with the second parameter value of 0.8 and the emotion of amazement with the second parameter value of 0.2, the displayed first facial expression information is facial expression information adapted to the state of surprise, and the first facial expression information is specifically adapted to a combination of “happiness” with an emotional intensity of 0.8 and “amazement” with an emotional intensity of 0.2.

It can be seen that in the embodiment of the disclosure, the electronic device firstly receives the first parameter value used to represent the intensity of the first emotion, and then displays the first facial expression information adapted to the first parameter value of the first basic emotion when the first emotion is the first basic emotion. This achieves the function of creating facial expression information based on a parameter value of a basic emotion. Since the parameter value is a unique numerical value, representing the specific intensity of a particular emotion, within the emotional intensity distribution range of the basic emotion, the electronic device can finely create more natural facial expression information based on the constraint information of linearly distributed ranges, which enhances the refinement level and scenario applicability of the condition-controllable facial expression information function. Furthermore, due to the service timing mechanism of the electronic device of “acquire first, output later”, the stability and accuracy of data processing can be improved when the electronic device operates the condition-controllable facial expression information function.

In one possible example, the operation of displaying the first facial expression information adapted to the first parameter value of the first basic emotion includes the following operations. A first encoding is performed on the first parameter value of the first basic emotion to obtain first feature dimension data, and the first feature dimension data has a correlation with a facial expression. The first feature dimension data and second feature dimension data are fused to obtain a first disentangled representation vector, and the second feature dimension data has no correlation with the facial expression. A data coupling transformation is performed on the first disentangled representation vector to obtain a first representation vector. A first decoding is performed on the first representation vector to obtain the first facial expression information.

The first representation vector is a feature vector of a facial expression image, and the first feature vector is used to represent at least one of the following information of the facial expression image: image feature information, image semantic information, or image spatial relationship information.

The second feature dimension data may be, for example, data having a correlation with information such as identity, posture, and background in the image.

The method for generating facial expression information described in the disclosure may specifically be implemented based on a first model. The first model includes a first sub-model, a second sub-model, a third sub-model, a fourth sub-model, and a fifth sub-model; the second sub-model and the fourth sub-model constitute a first autoencoder model, while the third sub-model and the fifth sub-model constitute a second autoencoder model. Specifically, the first sub-model may encode the parameter value of the basic emotion to obtain the feature dimension data that corresponds to the parameter value of the basic emotion and has a correlation with the facial expression, or the first sub-model may decode the feature dimension data having a correlation with the facial expression to obtain the parameter value of the basic emotion corresponding to the feature dimension data having a correlation with the facial expression. The second sub-model may encode the facial expression image to obtain the representation vector of the facial expression image, that is to say, an image is mapped into a representation vector. The fourth sub-model may decode the representation vector of the facial expression image to obtain facial expression information of the facial expression image, that is to say, a representation vector is mapped into an image. The third sub-model may perform a data decoupling transformation on the feature vector of the facial expression image to obtain a disentangled representation vector. The fifth sub-model may perform a data coupling transformation on the disentangled representation vectors to obtain the feature vector of the facial expression image.

Preforming the first encoding on the first parameter value of the first basic emotion through first sub-model to obtain the first feature dimension data may specifically be that the fifth feature dimension data having a correlation with the facial expression is input into the first sub-model, the fifth feature dimension data is encoded by the first sub-model to obtain a sixth parameter value of the basic emotion corresponding to the fifth feature dimension data. Then, the loss value between the sixth parameter value and the first parameter value is calculated and gradient back-propagation calculation is performed, and the fifth feature dimension data is modified based on the gradient back-propagation calculation result. The modified fifth feature dimension data is encoded by the first sub-model and the gradient back-propagation calculation is performed again, and the fifth feature dimension data is modified again based on the gradient back-propagation calculation result. After repeating for many rounds, the parameter value output by decoding the modified fifth feature dimension data through the first sub-model may be matched with the first parameter value of the first basic emotion, and the modified fifth feature dimension data at this time may be used as the first feature dimension data.

In a specific implementation, the first sub-model may be a classification model, for example, a multilayer perceptron, a convolutional neural network, or a transformer model may be employed. The second sub-model and the fourth sub-model may be an encoding model and a decoding model, respectively. Specifically, the second sub-model and the fourth sub-model may employ, for example, a transformer model, a multilayer perceptron, or a convolutional neural network. The third sub-model and the fifth sub-model may specifically be a reversible model, for example, a normalizing flow model (a class of the INN) may be employed.

In the example, referring to FIG. 2B and FIG. 2C, the first encoding may be implemented through the first sub-model, the data coupling transformation may be implemented through the fifth sub-model, and the first decoding may be implemented through the fourth sub-model, so as to further improve the accuracy of data processing when generating the first facial expression information.

It can be seen that in the example, the electronic device firstly encodes the first parameter value of the first basic emotion to obtain the first feature dimension data having a correlation with the facial expression; then fuses the first feature dimension data and the second feature dimension data having no correlation with the facial expression to obtain the first disentangled representation vector; further performs the data coupling transformation on the first disentangled representation vector to obtain the first representation vector; and finally decodes the coupled first representation vector to obtain the first facial expression information. By adopting the service processing mechanism that progresses from local to global, it is beneficial for further improving the reliability of the facial expression information generation result.

In one possible example, before fusing the first feature dimension data and the second feature dimension data to obtain the first disentangled representation vector, the method further includes the following operations. The second feature dimension data is created by randomly sampling a preset facial expression image. Alternatively, an original facial expression image is acquired, a second encoding and a data decoupling transformation are performed on the original facial expression image to obtain a second disentangled representation vector, and the second feature dimension data, that has no correlation with the facial expression, in the second disentangled representation vector is extracted.

In the example, referring to FIG. 2C, the second decoding may be implemented through the second sub-model in the first model, and the data decoupling transformation may be implemented through the third sub-model in the first model.

With regard to the acquisition of the second feature dimension data, please continue to refer to FIG. 2B and FIG. 2C. FIG. 2B illustrates a manner of creating the second feature dimension data by randomly sampling, FIG. 2C illustrates a manner of extracting the second feature dimension data by acquiring the original facial expression image, and white circles in the second disentangled representation vector and the first disentangled representation vector in FIG. 2C correspond to the second feature dimension data.

In a specific implementation, there exist one or more preset facial expression images. When there is a single preset facial expression image, the electronic device may directly acquire the second feature dimension data based on the single preset facial expression image. When there are multiple preset facial expression images, in addition to creating the second feature dimension data by randomly sampling the multiple preset facial expression images, the electronic device may determine image content reference information based on input information (for example, one or more of text information, voice information, gesture information, etc.) acquired from the interaction system, and then screen out a preset facial expression image matching the image content reference information from the multiple preset facial expression images, and create the second feature dimension data based on the preset facial expression image matching the image content reference information.

For example, each of the multiple preset facial expression images may be associated with image content description information, the electronic device acquires text information input by the user through the interaction system, splits the content of the text information to determine that there is identity description information in the text information; and specifically, if the identity description information is a little girl, the electronic device may determine, from the multiple preset facial expression images, a preset facial expression image that the image content description information includes the little girl, and the second feature dimension data is further created based on the preset facial expression image that the image content includes the little girl, which improves the flexibility of generating the first facial expression information.

Referring to FIG. 2D to FIG. 2I, the image content description information may be, for example, information acquired by the electronic device that is input by a user through voice input, text input, or the like in a dialogue large model system, an artificial intelligence-generated content (AIGC) application, a digital human dialogue application, or an intelligent robot interaction application. Continuing to refer to FIG. 2D to FIG. 2h, the original facial expression image may be an image uploaded by the user, which is acquired by the electronic device when the electronic device detects an operation for an upload reference image control (for example, a control displaying a text “upload reference image” in FIG. 2E, and a control 01 displaying an image in FIG. 2D) in the dialogue large model system or the AIGC application. Alternatively, for example, in the digital human dialogue application or the intelligent robot interaction application scenario of FIG. 2I to FIG. 2I, the original expression image may be an image uploaded by the user, which is triggered and acquired based on voice interaction or gesture interaction content by the electronic device running the digital human dialogue application or controlled by the robot. In particular, for example, the user may upload an image by the following: acquiring a picture locally saved by the electronic device running the dialogue large model system, the AIGC application, or the digital human dialogue application; or an image acquired by the electronic device running the application from a cloud server, or acquiring by an image acquisition device set in the electronic device running the application or the intelligent robot.

In the intelligent robot interaction scenario, the intelligent robot may specifically acquire voice information and image through embodied intelligent perception unit (including sensors such as a auditory sensor, a visual sensor and a tactile sensor), and may further process the acquired voice information and image based on the embodied intelligent perception unit, and then adjust the facial expression image displayed on the screen of the intelligent robot head or the facial expression action state of the simulated face on the intelligent robot head based on the acquired voice information and image.

As another example, referring to FIG. 2G and FIG. 2h, the second feature dimension data of the generated image 2 in FIG. 2G that has no correlation with the expression is created based on the preset facial expression image (specifically, the preset expression image for creating the second feature dimension data may be an image determined from the multiple preset expression images, of which the image content matches the image description information “a little girl with curly hair” input by the user), while the second feature dimension data of the generated image 3 in FIG. 2H is extracted from the original facial expression image, that is, the reference image 1, so that except for facial expression, other image information such as identity and background in the reference image 1 and the generated image 3 remains consistent.

It can be seen that, in the example, the second feature dimension data may be created by randomly sampling the preset facial expression image, or the second feature dimension data may be acquired from the disentangled representation vector by acquiring the original facial expression image and performing encoding and data decoupling transformation on the original facial expression image. The manner of acquiring the second feature dimension data is flexible and diverse, which is beneficial to improving the scenario applicability of the facial expression information generation.

In one possible example, before receiving the first parameter value of the first emotion, the method further includes the following operations. An interaction operation for a component of an application interface is acquired. The first parameter value of the first emotion is acquired based on the interaction operation.

It can be seen that, in the example, the electronic device may acquire the first parameter value based on the interaction operation for the component of the application interface, and then generate the first facial expression information based on the acquired first parameter value. The user may realize a personalized configuration of the first facial expression information generation through the application interface, so that the facial expression information generation is more adapted to the real demands of the user, and the scenario applicability of the facial expression information generation is improved.

In one possible example, the component includes a numerical adjustment control for the first parameter value of the first basic emotion. The interaction operation is a numerical adjustment operation for the numerical adjustment control.

The numerical adjustment control may be, for example, a slider control, a knob control, an increase/decrease button combination control, a progress bar control, or the like. Correspondingly, the numerical adjustment operation may be a sliding operation on the slider control, a rotation operation on the knob control, a click operation on the increase/decrease button, a drag operation on the progress bar control, or the like. In addition, the application interface may further include a visualization material for the basic emotion and a visualization material for the first parameter value. The visualization material of the basic emotion may include, for example, graphics and/or text. The visualization material of the first parameter value may be, for example, a numerical display box.

Please continue to refer to FIG. 2G and FIG. 2H, in which taking an example where the numerical adjustment control is a slider control, the user may adjust and set the intensity of each basic emotion by sliding the corresponding slider for the basic emotions of happiness, sadness, amazement, fear, disgust and anger. At the same time, in order to facilitate the user to understand the operation manner and perceive the setting state of each emotion, in FIG. 2G and FIG. 2H, labels such as “happiness, sadness, amazement, fear, disgust and anger” and the numerical display boxes may also be used for prompting the user about the basic emotion type corresponding to each control, the adjustable numerical range of the intensity, the correspondence between the sliding direction of the slider and the changing trend of the numerical value, and the actual emotional intensity corresponding to each slider position after the sliding operation.

As illustrated in FIG. 2G and FIG. 2H, in combination with the prompt information “Slide to adjust the intensity of the basic emotion; the facial expression information in the generated image will adapt to the emotional setting here” along with the alignment of the set positions of multiple slider controls and the set positions of multiple visualization materials displaying “happiness, sadness, amazement, fear, disgust and anger”, the user may understand that the topmost slider control is used to adjust the intensity of happiness. Additionally, by set the visualization material “0” on the left side and the visualization material “1” on the right side of each slider, the user is prompted that sliding the slider to the left decreases the intensity, while sliding the slider to the right increases the intensity. Furthermore, through the numerical display box located at the far-right side of each slider control, the user may be prompted about the intensity of the basic emotion corresponding to the current position of the slider control. For instance, in FIG. 2H, the current position of the slider control corresponding to the emotion “happiness” represents that the intensity of the emotion “happiness” is 0.8.

It is to be understood that, in FIG. 2G and FIG. 2H, the display forms and positions of the numerical adjustment controls and the visualization materials are merely exemplary descriptions. In practical applications, the display forms and contents of the numerical adjustment controls and the visualization materials may be different from those illustrated in FIG. 2G and FIG. 2H. For example, the visualization materials corresponding to the basic emotion types may be not only text but also simple line drawing patterns corresponding to the respective basic emotions, which is not specifically limited here.

It can be seen that, in the example, the electronic device may directly determine the first parameter value of the first basic emotion based on the numerical adjustment operation of the numerical adjustment control. The adjustment and interaction operations of the first parameter value is simple and fast, which is beneficial to improve the interaction efficiency.

In one possible example, the component includes a first selection control for a first compound emotion, the application interface further displays a second selection control for a second compound emotion, and the second compound emotion is different from the first compound emotion. The interaction operation is a selection operation for the first selection control.

The visualization carrier of the first selection control is a display material of the first compound emotion, or the visualization carrier of the first selection control is a selection function material corresponding to the display material of the first compound emotion.

For example, please continue to refer to FIG. 2G and FIG. 2h, in which the display material of the first compound emotion is directly used as the visualization carrier of the first selection control. At this time, when the electronic device detects a selection operation for any one of the display materials of “surprise, embarrassment, melancholy, anxiety, jealousy, nostalgia, shame, pride”, the selected first compound emotion may be determined. For example, when the user directly clicks the display material “surprise”, the electronic device may determine that the first compound emotion is “surprise”. In a specific implementation, the electronic device may also display prompt information in the selection area of the first compound emotion to prompt the user about the operation manner, for example, the prompt information illustrated in FIG. 2G and FIG. 2h of “If you don't want to set the intensity of the basic emotion, you can directly select a compound emotion, and the intensities of various basic emotions corresponding to the compound emotion are automatically set”.

It is to be understood that, in FIG. 2G and FIG. 2H, the display form and position of the first selection control are merely exemplary descriptions. In practical applications, the display form and content of the first selection control may be different from those illustrated in FIG. 2G and FIG. 2H. For example, taking an example where the first compound emotion is “surprise”, in addition to the text of “surprise”, the display material of the first compound emotion may be a simple line drawing pattern corresponding to “surprise”; alternatively, the first selection control may not be the display material of the first compound emotion, for example, a selection function material such as a check-box pattern may be set below the text of “surprise” for the display material of the first compound emotion, and the check-box pattern is used as the first selection control, which is not specifically limited here.

It can be seen that, in the example, the electronic device may directly display the selection controls corresponding to the multiple compound emotions, and determine the first compound emotion based on the detected selection operation for the selection control, which is beneficial to improve the interaction efficiency.

In one possible example, the operation of acquiring the first parameter value of the first emotion based on the interaction operation includes the following operations. The first compound emotion is determined based on the selection operation for the first selection control. A first mapping relationship set is queried by using the first compound emotion as a query identifier, and a second basic emotion configuration corresponding to the first compound emotion is acquired. The second basic emotion configuration includes a second basic emotion and a second parameter value of the second basic emotion, and the mapping relationship set includes a correspondence between the first compound emotion and the second basic emotion configuration.

In a specific implementation, the first mapping relationship set may be preset in advance, and when it is detected that a certain compound emotion is selected, the first mapping relationship set may be directly queried to acquire a basic emotion configuration corresponding to the compound emotion, and then, the basic emotions included in the basic emotion configuration, that is, a second parameter value corresponding to each of the basic emotions, can be acquired, thereby improving the efficiency of compound emotion processing, and further improving the efficiency of generating the facial expression image based on the compound emotion.

For example, assuming that the user clicks on the display material “surprise” in FIG. 2H and the electronic device detects a click operation on the material “surprise”, determines that the first compound emotion is surprise, queries the first mapping relationship set and acquires a second basic emotion configuration corresponding to “surprise”. Assuming that the second basic emotion configuration includes the emotion “happiness” with the second parameter value of 0.8 and the emotion “amazement” with the second parameter value of 0.2, the displayed first facial expression information is facial expression information adapted to the state of surprise, and the first facial expression information is specifically adapted to a combination of “happiness” with an emotional intensity of 0.8 and “amazement” with an emotional intensity of 0.2.

It can be seen that, in the example, after the electronic device determines the first compound emotion based on the selection operation for the selection control, the electronic device may directly query the mapping relationships to acquire the second basic emotion configuration corresponding to the first compound emotion, use the second basic emotion configuration as the first parameter corresponding to the first compound emotion, and then directly generate the first facial expression image based on the second parameter of the second basic emotion in the second basic emotion configuration. By presetting the mapping relationship set between the compound emotions and the basic emotion configurations, it is beneficial to improve the efficiency of generating the facial expression information based on the compound emotion.

In one possible example, before receiving the first parameter value of the first emotion, the method further includes the following operations. Voice information and/or image information of a user is acquired. The first parameter value of the first emotion is acquired based on the voice information and/or the image information.

In a specific implementation, if the voice information is a directive voice that directly indicates the first parameter value of the first emotion, the operation of acquiring the first parameter value of the first emotion based on the voice information includes that a semantic analysis is performed on the directive voice to obtain the first parameter value of the first emotion.

For example, taking the dialogue content in FIG. 2F as an example, assuming that the text content corresponding to the avatar 2 in FIG. 2F is the text corresponding to the voice information of the user, after the user with nickname 1 asks “what emotional state should the expression of the character be adapted to?”, if the collected user voice is “happiness intensity of 0.8”, the user voice is a directive voice, and it may be determined through the semantic analysis that the first emotion is the basic emotion “happiness” and the emotional intensity of the emotion “happiness” is 0.8. Of course, in other embodiments, when the electronic device acquires a directive voice such as “Help me generate an expression image with a happiness intensity of 0.8” from the user in the interaction page or interaction scenario as illustrated in FIG. 2D to FIG. 2L, the electronic device may also directly perform the semantic analysis on the directive voice to determine that the first emotion is the basic emotion “happiness”, and the emotional intensity of the emotion “happiness” is 0.8.

When the interaction information includes voice information, and the voice information is a conversational utterance during human-machine dialogue, the operation of acquiring the first parameter value of the first emotion based on the voice information includes the following operations. An emotion analysis is performed on the conversational utterance to obtain an emotional state of the user. A second mapping relationship set is queried to obtain a basic emotion configuration adapted to the emotional state. The basic emotion configuration includes a basic emotion and a first parameter value of the basic emotion, and the second mapping relationship set includes correspondences between the emotional states and the basic emotion configurations.

For example, in the human-machine dialogue scenario, the natural user describes a very happy and unexpected event that encountered today in voice, and assuming that the interaction object on the electronic device side is a digital human, the electronic device may perform emotion analysis on the conversational utterances from the natural user to obtain that the emotional state of the user is a compound emotion state superimposed by a state of happiness and the state of surprise. The electronic device queries the second mapping relationship set to acquire the basic emotion configuration, adapted to this compound emotion state, of {“happiness” with an intensity of 0.8+ “amazement” with an intensity of 0.2}; and displays a facial expression of the digital human adapted to the {“happiness” with an intensity of 0.8+ “amazement” with an intensity of 0.2} to improve the interaction effect.

For another example, taking the dialogue content in FIG. 2I as an example, assuming that the second mapping relationship set includes the mapping relationship between the emotion state of happiness and the basic emotion configuration with the “happiness” intensity of 0.8, when the user says a conversational utterance “I've been in a good mood recently” in the process of dialogue, and after the emotion analysis is performed on the conversational utterance to determine that the emotion state of the user is “happiness”, the second mapping relationship set is queried, and it may be determined that the user is in the emotion state of happiness, and the corresponding basic emotion configuration is “happiness” intensity of 0.8. The facial expression of the digital human may be adjusted to adapt to an image with a “happiness” intensity of 0.8. For example, in FIG. 2I, when the digital human outputs the voice “I'm glad to hear that you've been in a good mood recently”, its facial expression is adjusted as an expression with a “happiness” intensity of 0.8. Further, as illustrated in FIG. 2I, in addition to displaying the nickname and image of the digital human, a dialogue subtitle may be displayed, and text information of the voice being output by the digital human may be displayed in the dialogue subtitle.

In particular, please continue to refer to the dialogue large model system pages illustrated in FIG. 2D to FIG. 2F and the digital human dialogue page illustrated in FIG. 2I, the above-mentioned voice information may be acquired when the electronic device detects a selection operation for a microphone function icon 03 or a call function icon 02, or a voice input icon illustrated in FIG. 2I. The display page illustrated in FIG. 2I may be displayed by jumping when the selection operation for the call function icon 02 displayed on the page illustrated in FIG. 2D or the selection operation for the voice dialogue control in the new dialogue function bar is detected. FIG. 2I illustrates an example where the electronic device only acquires the voice information upon detecting the selection operation for the voice input icon within the digital human dialogue page. In practical applications, the electronic device may also continuously acquire the voice information in the digital human dialogue page. In addition, for example, in the robot interaction scenarios illustrated in FIG. 2J to FIG. 2L, the voice information may be acquired in the process of voice interaction between the robot and the user.

In some implementations, if the interaction information includes image information and the image information is an image of a gesture action of a user, the operation of acquiring the first parameter value of the first emotion based on the image information includes that: the semantic analysis is performed on the image of the gesture action of the user to obtain the first parameter value of the first emotion. If the gesture action is a gesture language action for the number 8 in gesture language, the semantic analysis result may be that the first parameter value is 0.8.

In some implementations, if the interaction information includes image information and the image information is a facial expression image of a real user, the operation of acquiring the first parameter value of the first emotion based on the image information includes the following operations. The emotion analysis is performed on the facial expression image of the real user to obtain that the emotion state of the user is the state of sadness, a second mapping relationship set is queried to acquire the basic emotion configuration, adapted to the state of sadness, of {neutral of 0, happiness of 1, sadness of 0, amazement of 0, fear of 0, disgust of 0, and anger of 0}, and a facial expression of the humanoid robot that adapts to the {neutral of 0, happiness of 1, sadness of 0, amazement of 0, fear of 0, disgust of 0, and anger of 0} is displayed to improve the interaction effect.

On the basis of the foregoing, the representation form of the first facial expression information may specifically include any one of: a facial expression animation of a digital human (for example, the image of the digital human displayed in a circular display area in FIG. 2I); a facial expression image output by the dialogue large model application (such as the generated image 1 as illustrated in FIG. 2F); a facial expression image output by the AIGC application (such as the generated image 2 as illustrated in FIG. 2G and the generated image 3 as illustrated in FIG. 2H); a facial expression action state of the simulated face on the robot head (as illustrated in FIG. 2K and FIG. 2L, FIG. 2K and FIG. 2L illustrate the facial expression action states of the same robot corresponding to different emotions, and the change of the facial expression action state of the robot under different emotions may be realized by changing the motion information of one or more action units such as forehead, eyeballs, eyelids, cheek muscles and jaw of the simulated face of the robot); or a facial expression image displayed on the screen of the robot head (such as an expression image displayed on the black screen area of the robot face as illustrated in FIG. 2J, in which the intensities of different emotions may be presented through changes in shapes such as an eye image and a mouth image).

In practical applications, the robot that displays a facial expression image through a screen on the head may be, for example, any one of various specialized devices such as a smart display speaker, a mobile phone, an in-vehicle infotainment system, and a service robot in bank lobby. The dialogue large model application and the digital human application may also be, for example, an in-vehicle infotainment assistant and a mobile phone voice assistant, and the like.

In practical applications, please continue to refer to FIG. 2D to FIG. 2F, in the display page of the dialogue large model system, a fixed display area of common functions such as new dialogue, historical dialogue, favorites, etc. may also be set, and when the user clicks on a specific function in the fixed display area, the function page of the selected function is directly displayed on the right side, so that the user can conveniently use and switch the commonly used functions. For example, in the new dialogue function bar, a user can directly create a voice dialogue, an image generation dialogue or an image recognition dialogue. In the historical dialogue function bar, the historical dialogue records may be directly viewed. For example, after the dialogue of “Generate an image in which the expression is in a state of surprise” is finished, the electronic device saves the dialogue content, and when the selection operation for this historical dialogue is detected later, the previously saved dialogue content may be displayed again in the right-side area. The historical dialogue content of “Recognize an emotion corresponding to the facial expression image” is displayed in the same way, and will not be repeated here.

In the case of allowing the user to adjust the basic emotion configuration information corresponding to the compound emotion, assuming that the user sets a basic emotion configuration template 1 to include: the compound emotion “surprise” corresponding to a basic emotion configuration {happiness of 0.7+amazement of 0.3}. When a selection operation for the basic emotion configuration template 1 in the favorites function bar is detected, a correspondence between the compound emotion “surprise” and the basic emotion configuration {happiness of 0.7+amazement of 0.3} may be displayed on the right-side page. At the same time, an adjustment control for the basic emotion configuration or a basic emotion configuration template usage control may be displayed on the page. When a selection operation for the basic emotion configuration template usage control is detected, the facial expression information may also be generated based on the basic emotion configuration. When a selection operation for a basic emotion configuration template 2 is detected, the configuration information corresponding to the basic emotion configuration template 2 may be displayed accordingly, and the specific display form may be described with reference to the above description for the basic emotion configuration template 1, which will not be repeated here.

Specifically, the initial page of the dialogue large model may be as illustrated in FIG. 2D, and when the electronic device detects a selection operation for an image generation control in the new dialogue function bar on the left side of FIG. 2D, or when the electronic device detects a selection operation for the image generation control displayed on the right side of FIG. 2D, or when the electronic device detects that the semantic information of the text information input into the input box in FIG. 2D matches the image generation function, the content displayed on the page may be switched into a function page corresponding to the image generation function.

In particular, as illustrated in FIG. 2E, before image content description information is detected, display images corresponding to different image generation subdivision functions may be displayed on the image generation page, and image content description information of the respective display image corresponding to each image generation subdivision function may be displayed in display area of the display image. For example, the text information displayed in the display image 1 in FIG. 2E is: a little girl in an amusement park, with an expression adapted to the state “happy”, and the intensity of the emotion “happiness” being 0.8. The user is prompted about the subdivision functions supported by the image generation, and the content forms of the image content description information under the subdivision functions.

When a selection operation for a “generate same version” control in the display image is detected, the subdivision function page corresponding to the display image may be jumped to and displayed. For example, the electronic device may jump to and display the page as illustrated in FIG. 2F after detecting a selection operation for the “generate same version” control in the display image 1 in FIG. 2E. Specifically, referring to the interaction content between the dialogue model (corresponding to the avatar 1) and the user (corresponding to the avatar 2) in FIG. 2F, in the dialogue large model system, the user may be guided to input the emotion parameter of the first emotion (i.e., the “happiness” intensity of 0.8) by setting a dialogue script, and the first facial expression information (i.e., the generated image 1), generated based on the emotion parameter of the first emotion input by the user, may be directly displayed on the dialogue page.

In particular, the dialogue script may include prompt information for prompting the user about the operation manner. For example, in FIG. 2F, the prompt information “Hello, User 1. Please describe to me an image background and a character identity you imagine, or directly upload a reference image for which you want to modify the expression, or let me randomly generate the image background and the character” may prompt the user that the image background and the character identity (that is, the second feature dimension data) may be simply described, or the reference image may be directly uploaded, or the image background and the character may be randomly generated by the electronic device. “What emotional state should the expression of the character be adapted to? You can describe the intensities of various emotions such as happiness, sadness, amazement, fear, disgust and fear; the intensity may be a number between 0 and 1, and the larger the number, the stronger the intensity of the emotion; you can directly select any one of emotions such as surprise, embarrassment, melancholy, anxiety, jealousy, nostalgia, shame, and pride”, may prompt the user about the basic emotion type and the compound emotion type, as well as prompt the user about setting manner for the intensity of the basic emotion type.

Furthermore, in order to improve the interaction efficiency, prompt information of “Try uploading facial expression image to recognize the emotion” and “Try specifying an emotion to generate a corresponding expression image” as illustrated in FIG. 2D, and prompt information of “Describe image content you want to generate, for example, specify an emotion to generate an image with a corresponding expression, or specify an emotion to modify an expression of an image” in FIG. 2E, prompt the user about specific operations supported by the image recognition function and the image generation function.

It can be seen that, in the example, the electronic device may acquire the first parameter value of the first emotion based on the acquired voice information and/or the image information of the user, and the manner of acquiring the parameter value of the emotion is flexible and diverse, which is beneficial to improve the scenario applicability of the facial expression information generation.

In one possible example, the method further includes the following operations. When the first emotion is a first compound emotion, a basic emotion analysis on the first parameter value of the first compound emotion is performed to obtain a second parameter value of a second basic emotion. The first facial expression information adapted to the second parameter value of the second basic emotion is displayed.

Different from FIG. 2G and FIG. 2H where the user directly selects the first compound emotion, the electronic device directly acquires the second basic emotion configuration, corresponding to the first compound emotion, as the first parameter value based on the first mapping relationship. In the example, the electronic device may further receive a specification for the second parameter values of the second basic emotions in the first compound emotion. That is to say, the second basic emotion types corresponding to the first compound emotion, and the second parameter value of each of the second basic emotions may be set by the user. For example, the representation form of the first parameter value received by the electronic device may be: happiness of 0.3+amazement of 0.7. By analyzing the first parameter value, it may be determined that the second parameter value of the second basic emotion “happiness” is 0.3, and the second parameter value of the second basic emotion “amazement” is 0.7.

It should be noted that, the representation form of the first parameter value in the example is merely an exemplary description, and in practical applications, the first parameter value may be set to another representation form (different from the representation form in this example) for indicating the respective second parameter value corresponding to each of second basic emotions. For example, the representation form of the first parameter may be that: the basic emotion type includes “happiness” and “amazement”, and the intensity ratio between happiness and amazement is 3:7, etc., which is not specifically limited here.

It can be seen that, in the example, the second parameter values of the second basic emotions corresponding to the first compound emotion may be obtained by performing a basic emotion analysis on the first parameter value, which is beneficial to improve the flexibility of the facial expression information generation.

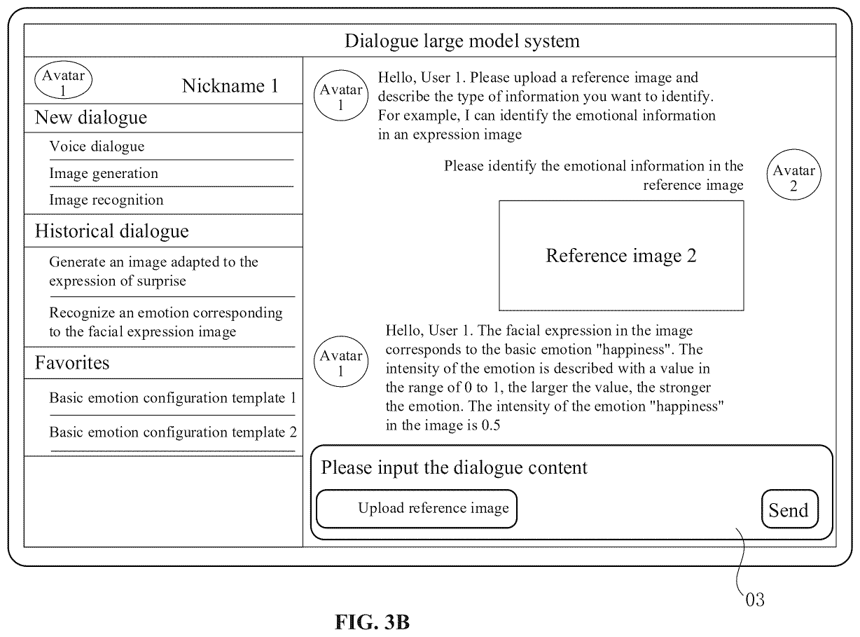

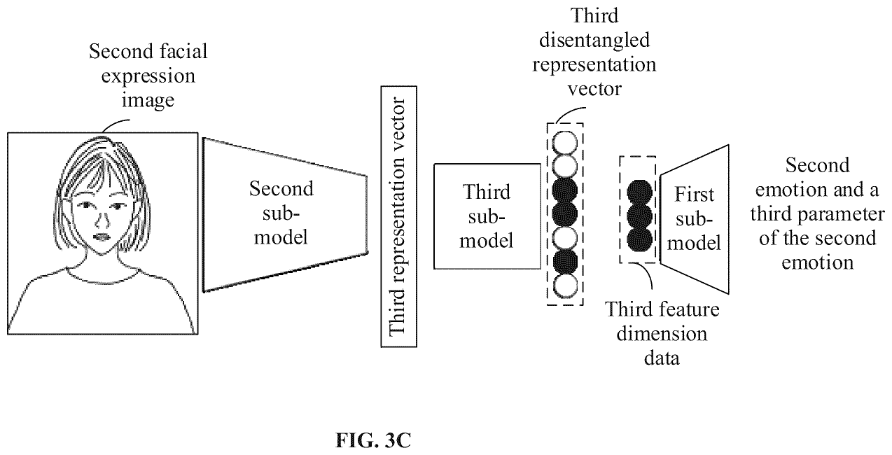

Referring to FIG. 3A, it is a flowchart of a method for recognizing an emotion according to an embodiment of the disclosure. The method may be applied to the electronic device 101 as illustrated in FIG. 1, and as illustrated in FIG. 3A, the method includes the following operations.

In operation S301, an electronic device acquires a second facial expression image.

In operation S302, the electronic device displays a second emotion adapted to the second facial expression image and a third parameter value of the second emotion.

When the second emotion is a third basic emotion, the third parameter value is used to represent an intensity of the third basic emotion.

In a specific implementation, referring to FIG. 3B, taking an example where the method for recognizing the emotion is applied to the large dialogue model system, FIG. 3B may be displayed after detecting the selection operation for the image recognition control in FIG. 2B. Specifically, referring to the interaction content between the dialogue model (corresponding to the avatar 1) and the user (corresponding to the avatar 2) in FIG. 3B, in the dialogue large model system, the user may be guided to upload the reference image (that is, the reference image 2) and input image information to be recognized by setting the dialogue script. When detecting that the image information to be recognized is emotion information, the second emotion (i.e., “happiness”) corresponding to the reference image 2 and the third parameter (i.e. 0.5) of the second emotion may be output, and explanation information for the parameter value, such as “The intensity of the emotion is described with a value in the range of 0 to 1, where the larger the value, the stronger the emotion”, may be displayed to prompt the user about the actual meaning of the parameter value.

It can be seen that in the embodiment of the disclosure, the second facial expression image is acquired firstly, and the second emotion adapted to the second facial expression image and a third parameter value of the second emotion are displayed. When the second emotion is the third basic emotion, the third parameter value is used to represent the intensity of the third basic emotion. The function of recognizing an emotion based on a facial expression image is achieved. Since the outputted parameter value is within the emotional intensity distribution range of the basic emotion and reflects uniquely an intensity of an exclusive emotion, the refinement level and scenario applicability of the emotion recognition function is enhanced. Furthermore, due to the service timing mechanism of the electronic device of “acquire first, output later”, the stability and accuracy of data processing can be improved when the electronic device operates the emotion recognition function.

In one possible example, the operation of displaying the second emotion adapted to the second facial expression image and the third parameter value of the second emotion includes the following operations. A third encoding is performed on the second facial expression image to obtain a third representation vector. A data decoupling transformation is performed on the third representation vector to obtain a third disentangled representation vector. Third feature dimension data that has a correlation with a facial expression is extracted in the third disentangled representation vector. A third decoding is performed on the third feature dimension data to obtain the second emotion and the third parameter value of the second emotion.

Referring to FIG. 3C, the third decoding may be implemented through the second sub-model in the first model, the data decoupling transformation is implemented through the third sub-model in the first model, and the third decoding may be implemented through the first sub-model in the first model, thereby further improving the accuracy of the emotion recognition result.

In a specific implementation, the first sub-model may be a classification model. After the first sub-model performs the third decoding on the third feature dimension data, the first sub-model may specifically output a probability distribution of the third feature dimension data corresponding to each of basic emotion types, and the probability value may be used as the third parameter value.

It can be seen that, in the example, the electronic device firstly performs the third encoding on the second facial expression image to obtain the third representation vector; then performs the data decoupling transformation on the third representation vector to obtain the third disentangled representation vector; finally extracts the third feature dimension data that has the correlation with the facial expression in the third disentangled representation vector, and performs the third decoding on the third feature dimension data to obtain the second emotion and the third parameter value of the second emotion. By adopting the analysis mechanism that progresses from global to local, it is beneficial for improving the accuracy of the emotion recognition result.

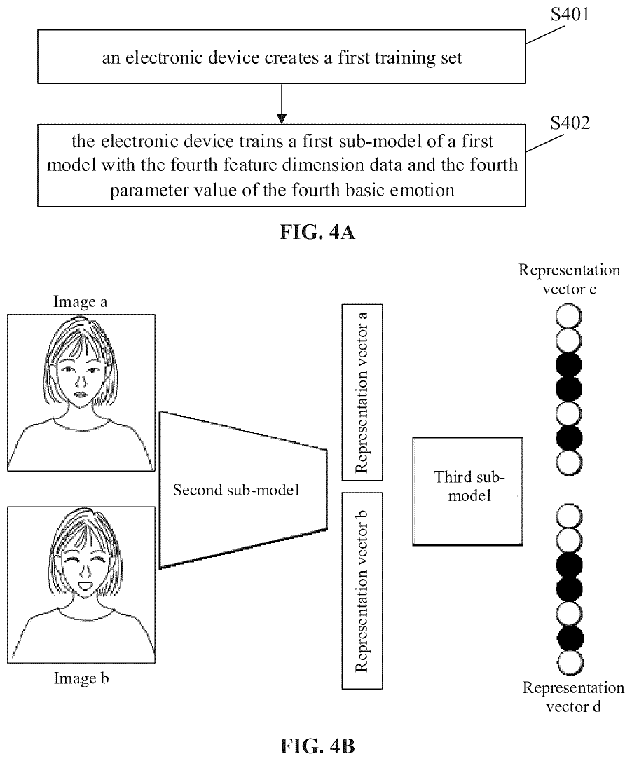

Referring to FIG. 4A, it is a flowchart of a method for training a model according to an embodiment of the disclosure. The method may be applied to the electronic device 101 as illustrated in FIG. 1, and as illustrated in FIG. 4A, the method includes the following operations.

In operation S401, an electronic device creates a first training set.

The first training set includes fourth feature dimension data and a fourth parameter value of a fourth basic emotion, the fourth feature dimension data has a correlation with a facial expression, and the fourth parameter value is used to represent an intensity of the fourth basic emotion.

In operation S402, the electronic device trains a first sub-model of a first model with the fourth feature dimension data and the fourth parameter value of the fourth basic emotion.

The first sub-model may be trained by using a cross-entropy loss function.

The first training set may be acquired based on the standard data set historically released by a third-party organization. The first training set includes the fourth feature dimension data and the fourth parameter value of the fourth basic emotion, that is to say, the fourth feature dimension data in the first training set has been labeled with label information (i.e., the fourth parameter value of the fourth basic emotion).

It can be seen that in the embodiment of the disclosure, the first training set including the fourth feature dimension data and the fourth parameter value of the fourth basic emotion is created firstly, and then, the first sub-model of the first model is trained with the fourth feature dimension data and the fourth parameter value of the fourth basic emotion. Since the fourth feature dimension data has a correlation with the facial expression, and the fourth parameter value is used to represent the intensity of the fourth basic emotion, the first sub-model trained based on the first training set can accurately mine the intrinsic correlation between the feature dimension data related to the facial expression and the numerical value within the intensity range of the basic emotion that reflects uniquely an intensity of an exclusive emotion. Based on this, the trained first sub-model can finely create more natural facial expression information based on the parameter value that represents the intensity of the emotion. Alternatively, the trained first sub-model can output a parameter value that finely represents the intensity value of the emotion based on the feature dimension data related to the facial expression. This enhances the refinement level of the condition-controllable facial expression information function and the emotion recognition function, as well as improves the accuracy of data processing when the electronic device operates the conditional controllable facial expression information function and the emotion recognition function.

In one possible example, the operation of creating the first training set includes the following operations. A first face image set is acquired, and a first face image in the first face image set includes a fifth parameter value of a fifth basic emotion. A fourth encoding is performed on the first face image to obtain a second representation vector. A data decoupling transformation is performed on the second representation vector to obtain a third disentangled representation vector. The fourth feature dimension data that has the correlation with the facial expression is extracted in the third disentangled representation vector. The fifth parameter value of the fifth basic emotion is processed by adopting a label softening technique to obtain the fourth parameter value of the fourth basic emotion. The first training set is created based on the fourth feature dimension data and the fourth parameter value of the fourth basic emotion.

The fourth encoding may be implemented through the second sub-model in the first model, and the data decoupling transformation may be implemented through the third sub-model in the first model.

In a specific implementation, the first face image set is the standard data set historically released by the third-party organization, and the fifth parameter is label information labeled in the standard data set. Considering that the fifth parameter exhibits a characteristic of “hardness”, that is, its probability value is either 1 or 0, the fifth parameter value is softened to the fourth parameter value by performing the label softening processing on the fifth parameter value, so that the softened fourth parameter value is between 0 and 1, and then the first training set for training the first sub-model is obtained, so as to improve the training effect.

For example, taking an example where the standard data set (i.e., the first face image set) acquired from the third-party organization includes a basic emotion “a” corresponding to the face image 1, and the fifth parameter value corresponding to the basic emotion “a” is 1 (hereinafter briefly referred to as the basic emotion “a” and the parameter value of 1), the fourth feature dimension data, that has the correlation with the facial expression, of the face image 1 is obtained after processing the face image 1, and the fifth parameter value of 1 corresponding to the basic emotion “a” is softened to the fourth parameter value of 0.7, and finally the data corresponding to the face image 1 in the first training data set is transformed from (the basic emotion “a” and the parameter value of 1) into (the fourth feature dimension data and the parameter value of 0.7).

It can be seen that, in the example, the electronic device extracts feature dimension data that has the correlation with the facial expression for the fifth basic emotion in the first face image set; and performs the label softening processing on the parameter values of basic emotions in the first face image set, and creates the training set for the feature dimension data that has the correlation with the facial expression and is labeled with the softened labels. This approach is beneficial for enhancing the training effect of training the first sub-model based on the first training set, thereby improving the accuracy of the trained first sub-model in generating parameter values of basic emotions based on the feature dimension data related to the expression, or the accuracy of the trained first sub-model in generating the feature dimension data related to the expression based on the parameter values of basic emotions.

In one possible example, the method further includes the following operations. A second face image set is created, and the second face image set includes multiple second face images with different facial expressions. A fifth encoding is performed on each of the multiple second face images to obtain multiple third representation vectors. A data decoupling transformation is performed on the multiple third representation vectors to obtain multiple fourth disentangled representation vectors. A facial expression correlation analysis is performed on the multiple fourth disentangled representation vectors to obtain the correlation between the fourth feature dimension data and the facial expression.

None of the multiple second face images in the second face image set includes a parameter value of a basic emotion.

In a specific implementation, the fifth encoding may be implemented through the second sub-model in the first model, and the data decoupling transformation may be implemented through the third sub-model in the first model. Referring to FIG. 4B, taking an example where the multiple second face images included in the second face image set are image “a” and image “b”, the fifth coding is respectively performed on the image “a” and the image “b” through the second sub-model, to obtain the third representation vectors (i.e., representation vector “a” and representation vector “b”) corresponding to the image “a” and the image “b”, respectively; and then the data decoupling transformation is performed on the representation vector a and the representation vector b, respectively, to obtain the multiple fourth disentangled representation vectors (i.e., representation vector c and representation vector d); and then the facial expression correlation analysis is performed on the multiple fourth disentangled representation vectors, to obtain the correlation between the fourth feature dimension data and the facial expression.

Specifically, since the main difference among the multiple second face images included in the same second face image set is facial expression, the correlation analysis may be specifically determined by comparing the vector differences between the representation vector c and the representation vector d in each dimension. For example, in FIG. 4B, if the vector difference between the representation vector c and the representation d is largest in the dimension corresponding to a black circle, it may be determined that there is a certain correlation between the dimension data corresponding to the black circle and the facial expression, and the dimension data corresponding to the black circle is more likely to be the fourth feature dimension data. By cross-validating among multiple sets of data, the fourth feature dimension data related to the expression may be determined, and subsequently, the correlation between the fourth feature dimension data and the facial expression may be determined.

The method for determining changes within the same dimension may be, for example, to calculate the variance between sub-vectors of the same dimension.

In a specific implementation, the multiple second face images included in the same face image set may select images in which the differences of other image information (such as identity, background, etc.) except facial expression are all less than a preset value, which is beneficial to improve the accuracy of the facial expression correlation analysis result.

It can be seen that, in the example, the electronic device creates the second face image set including multiple second face images with different facial expressions; processes and then performs a fifth encoding on each of the multiple second face images to obtain third representation vectors; performs a data decoupling transformation on the third representation vectors to obtain multiple fourth disentangled representation vectors; and finally performs a facial expression correlation analysis on each of the multiple fourth disentangled representation vectors to obtain the correlation between the fourth feature dimension data and the facial expression, which is beneficial to improve the accuracy of the facial expression correlation analysis result.

In one possible example, the operation of performing the fifth encoding on each of the multiple second face images to obtain the multiple third representation vectors includes that: the fifth encoding is performed on each of the multiple second face images by calling a second sub-model of the first model to obtain the multiple third representation vectors. The operation of performing the data decoupling transformation on the multiple third representation vectors to obtain the multiple fourth disentangled representation vectors includes that: the data decoupling transformation is performed on the multiple third representation vectors by calling a third sub-model of the first model to obtain the multiple fourth disentangled representation vectors. The method further includes the following operations. A third face image set is created, and the third face image set includes third face images. The second sub-model of the first model and a fourth sub-model of the first model are trained based on the third face images. The third sub-model of the first model and a fifth sub-model of the first model are trained based on the third face images.

In an embodiment of the disclosure, the second sub-model and the fourth sub-model constitute a first autoencoder model, while the third sub-model and the fifth sub-model constitute a second autoencoder model. Since the second sub-model and the fourth sub-model are first trained in the first stage, and the third sub-model and the fifth sub-model are trained in the second stage, the model parameters of the second sub-model and the fourth sub-model are no longer updated (that is, the model parameters are frozen) during the training process in the second stage. That is to say, the second sub-model and fourth sub-model are trained firstly until the quality of the generated images meets the required standards, and then the second sub-model and fourth sub-model are frozen before proceeding to further train the third sub-model and the fifth sub-model. Compared to the existing mechanism where the second sub-model, the fourth sub-model, the third sub-model, and the fifth sub-model are all trained in a single training stage, this approach can avoid the problem of conflict between the disentangling of representation vector and the generation image quality of the decoding model that arises in the existing mechanism.

The third face images are pre-processed face images, the pre-processing includes face detection and/or face alignment, and the third face images do not include a parameter value of a basic emotion.

It can be seen that, in the example, the electronic device performs the encoding processing on the face image and the data decoupling transformation on the representation vector through the models, and the models used for encoding and data decoupling transformation are trained by using the third face image set, which is beneficial to improve the accuracy of the encoding result and the data decoupling transformation result.

In one possible example, the operation of training the second sub-model of the first model and the fourth sub-model of the first model based on the third face images includes the following operations. A first prediction processing is performed on each of the third face images based on the second sub-model and the fourth sub-model to obtain a first prediction face image. A first loss calculation is performed on the third face image and the first prediction face image based on a first loss function to obtain a first loss value. A first gradient calculation is performed on model parameters of the second sub-model and the fourth sub-model based on the first loss value and the first loss function to obtain a first gradient value. The model parameters of the second sub-model and the fourth sub-model are adjusted based on the first gradient value to obtain the second sub-model and the fourth sub-model.

The operation of performing the first gradient calculation on the model parameters of the second sub-model and the fourth sub-model based on the first loss value and the first loss function to obtain the first gradient value includes the following operations. A first gradient function calculation is performed on the model parameters of the second sub-model and the fourth sub-model based on the first loss function to obtain a first gradient function of the model parameters. The first gradient calculation is performed on the model parameters based on the first loss value and the first gradient function to obtain the first gradient value.

It can be seen that, in the example, the electronic device performs the loss calculation on an initial third face image and the first prediction face image (that obtained by performing first prediction processing on the third face image through the second sub-model and the fourth sub-model); performs the gradient calculation based on the loss calculation result; and finally adjusts the model parameters of the second sub-model and the fourth sub-model based on the gradient calculation result. The application of gradient algorithm is beneficial to reduce computational overhead during training, improve the training efficiency of the second sub-model and the fourth sub-model, and save resources consumed by the electronic device.

In one possible example, the operation of performing the first loss calculation on the third face image and the first prediction face image based on the first loss function to obtain the first loss value includes the following operations. An image pixel difference processing is performed on the third face image and the first prediction face image to obtain an image pixel difference result. An image feature dimension difference processing is performed on the third face image and the first prediction face image to obtain an image feature dimension difference processing result. The first loss value is determined based on the image pixel difference result and the image feature dimension difference processing result.

The pixel difference may be, for example, calculated as an absolute difference or a square difference of the pixel values. The calculated pixel difference may quantify the difference between the third face image and the first prediction face image in aspects such as brightness, color.

The image feature dimension difference mainly calculates the difference between the third face image and the first prediction face image in the feature space. For example, the image feature dimension difference may be calculated by using methods such as Euclidean distance or cosine similarity between image feature vectors.

The first loss value may specifically be a weighted result of the image pixel difference and the image feature dimension difference, and the respective weights of the image pixel difference and the image feature dimension difference may be preset as needed, which is not specifically limited here.

Specifically, on the one hand, the L1 loss function may be used to measure the image pixel difference between the third face image and the first prediction face image, thereby constructing a reconstruction loss function L_{rec}, and then the L_{rec} may specifically be determined by the following formula:

$${L}_{rec} = {L}_{1} ( x - \hat{x} ) ;$$

where \hat{x}=D(E(x)) represents the first prediction face image, and x represents the third face image. The L1 loss function quantizes the error by calculating the average of the absolute difference between the predicted value and the real value, that is to say, the image pixel difference between the third face image and the first prediction face image calculated based on the reconstruction loss function is the average of the absolute difference.

On the other hand, the pre-trained VGG19 neural network model may be used to measure the differences (i.e., the image feature dimension difference) between the third face image and the first prediction face image at multiple feature dimension levels, so as to construct a perceptual loss function Lₚₑᵣ, and the Lₚₑᵣ may specifically be determined by the following formula:

$${L}_{per} = \frac{1}{N} {\sum }_{i = 1}^{N} {( {VGG}_{i} ( x ) - {VGG}_{i} ( \hat{x} ) )}^{2} ;$$

where N represents the number of network layers in the VGG19 neural network model. VGGᵢ(x) represents the feature representation obtained by the i-th layer of the VGG19 neural network model when the third face image is processed through the VGG19 neural network model, and VGGᵢ(\hat{x}) represents the feature representation obtained by the i-th layer of the VGG19 neural network model when the first prediction face image is processed through the VGG19 neural network model.

On this basis, it may be determined that the final first loss function is:

$$L ( x , \hat{x} ) = {λ}_{1} * {L}_{rec} + {λ}_{2} * {L}_{per} .$$

Where the values of weights λ₁ and λ₂ may be preset as needed.

It can be seen that, in the example, the first loss value is determined together based on the pixel-level difference at the low level and the semantic feature difference at the high-level, which is beneficial to improve the training effect of the second sub-model and the fourth sub-model.

In one possible example, the operation of training the third sub-model of the first model and the fifth sub-model of the first model based on the third face images includes the following operations. A second prediction processing is performed on each of the third face images based on the second sub-model, the third sub-model, the fourth sub-model and the fifth sub-model to obtain a second prediction face image. A sixth encoding is performed on the third face images by calling the second sub-model to obtain a plurality of fourth representation vectors. A data decoupling transformation is performed on each of the plurality of fourth representation vectors by calling the third sub-model to obtain a fifth disentangled representation vector. A second loss calculation is performed on the third face image, the fourth representation vector, the fifth disentangled representation vector and the second prediction face image based on a second loss function to obtain a second loss value. A second gradient calculation is performed on model parameters of the third sub-model and the fifth sub-model based on the second loss value and the second loss function to obtain a second gradient value. The model parameters of the third sub-model and the fifth sub-model are adjusted based on the second gradient value to obtain the third sub-model and the fifth sub-model.

In a specific implementation, since the second gradient value is computed only for the model parameters of the third sub-model and the fifth sub-model during the gradient calculation operation, and the corresponding model parameters are updated based on the second gradient values, the model parameters of the second sub-model and the fourth sub-model are no longer computed and updated (that is, the model parameters are frozen) during the training process in the second stage. That is to say, the second sub-model and fourth sub-model are trained firstly until the quality of the generated images meets the required standards, and then the second sub-model and fourth sub-model are frozen before proceeding to further train the third sub-model and the fifth sub-model. Compared to the existing mechanism where the second sub-model, the fourth sub-model, the third sub-model, and the fifth sub-model are all trained in a single training stage, this approach can avoid the problem of conflict between the disentangling of representation vector and the generation image quality of the decoding model that arises in the existing mechanism.

The operation of performing the second gradient calculation on the model parameters of the third sub-model and the fifth sub-model based on the second loss value and the second loss function to obtain the second gradient value includes the following operations. A second gradient function calculation is performed on the model parameters of the third sub-model and the fifth sub-model based on the second loss function to obtain a second gradient function of the model parameters. The second gradient calculation is performed on the model parameters based on the second loss value and the second gradient function to obtain the second gradient value.

It can be seen that, in the example, the electronic device performs the loss calculation on an initial third face image and the second prediction face image (that obtained by performing second prediction processing on the third face image based on the second sub-model, the third sub-model, the fourth sub-model and the fifth sub-model); performs the gradient calculation based on the loss calculation result; and finally adjusts the model parameters of the third sub-model and the fifth sub-model based on the gradient calculation result. The application of gradient algorithm is beneficial to reduce computational overhead during training, improve the training efficiency of the third sub-model and the fifth sub-model, and save resources consumed by the electronic device.

In one possible example, the operation of performing the second loss calculation on the third face image, the fourth representation vector, the fifth disentangled representation vector and the second prediction face image based on the second loss function to obtain the second loss value includes the following operations a1 to a5.

In operation a1, an image pixel difference processing is performed on the third face image and the second prediction face image to obtain an image pixel difference result.

The image pixel difference result may specifically be a loss value calculated based on the following reconstruction loss function L_{rec}:

$${L}_{rec} = {L}_{1} ( x - \hat{x} )$$

where x represents the third face image, and \hat{x} represents the second prediction face image. The L1 loss function quantizes the error by calculating the average of the absolute difference between the predicted value and the real value, that is to say, the image pixel difference between the third face image and the second prediction face image calculated based on the reconstruction loss function is the average of the absolute difference.

Specifically, the second prediction face image \hat{x}=D(T⁻¹(T(E(x)) Where D corresponds to the fourth sub-model, E corresponds to the second sub-model, T corresponds to the third sub-model, and T⁻¹ corresponds to the fifth sub-model. T(E(x)) represents the fifth disentangled representation vector f. That is to say, the second prediction face image \hat{x} is obtained by performing the decoding processing on the fifth representation vector through the fourth sub-model, and the fifth representation vector is obtained by performing the data coupling transformation on the fifth disentangled representation vector f through the fifth sub-model.

In operation a2, an image feature dimension difference processing is performed on the third face image and the second prediction face image to obtain an image feature dimension difference processing result.

The image pixel difference result may specifically be, after processing the third face image and the second prediction face image by using the pre-trained VGG19 neural network model, a loss value calculated based on the following perceptual loss function Lₚₑᵣ:

$${L}_{per} = \frac{1}{N} {\sum }_{i = 1}^{N} {( {VGG}_{i} ( \hat{x} ) )}^{2} .$$

Where N represents the number of network layers in the VGG19 neural network model. VGGᵢ(x) represents the feature representation obtained by the i-th layer of the VGG19 neural network model when the third face image is processed through the VGG19 neural network model, and VGGᵢ(\hat{x}) represents the feature representation obtained by the i-th layer of the VGG19 neural network model when the second prediction face image is processed through the VGG19 neural network model.

In operation a3, a feature dimension disentangled probability distribution proximity calculation is performed on the fourth representation vector and the fifth disentangled representation vector to obtain a feature dimension disentangled probability distribution proximity.

The feature dimension disentangled probability distribution proximity may be a loss value calculated through the following KL divergence loss function L_{KL}:

$${L}_{KL} = KL ( P ( f \vert z ) \vert \vert {P}_{prior} ( f ) .$$

Where Pₚᵣᵢₒᵣ(f) represents the prior probability distribution of the feature dimension disentangled probability of the fifth disentangled representation vector f, P(f|z) represents the actual feature dimension disentangled probability distribution of the fifth disentangled representation vector f under the given fourth representation vector z. The KL divergence loss function L_{KL} is used to quantify divergence between P(f|z) and the prior probability distribution Pₚᵣᵢₒᵣ(f). In this training process, the final loss function aims to make the actual disentangled probability distribution close to the prior disentangled probability distribution.

Specifically, data, in respective feature dimensions, of the fifth disentangled feature vector are independent of each other, and modifying the data of one feature dimension does not affect other feature dimensions. Based on this, the prior probability distribution of the feature dimension disentangled probability of the fifth disentangled representation vector may be determined by the following formula:

$${P}_{prior} ( f ) = {\prod }_{i} {P}_{prior} ( {f}_{i} ) .$$

Where fᵢ represents data in the i-th feature dimension of the fifth disentangled representation vector f, Pₚᵣᵢₒᵣ(f) represents the overall prior probability of the fifth disentangled representation vector f, Pₚᵣᵢₒᵣ(fᵢ) represents the prior probability of feature dimension data fᵢ, and ΠᵢPₚᵣᵢₒᵣ(fᵢ) represents the product of the prior probabilities of all feature dimension data fᵢ. That is to say, the overall probability of the fifth disentangled representation vector f is equal to the product of independent probabilities of respective feature dimension data fᵢ.

Furthermore, in order to transform the third sub-model and the fifth sub-model into a generation model, the probability distribution of each feature dimension data fᵢ of the fifth disentangled representation vector may be further constrained to conform to a standard normal distribution, i.e. Pₚᵣᵢₒᵣ(f)=ΠᵢPₚᵣᵢₒᵣ(fᵢ)=ΠᵢN(fᵢ|0, I).

Where N(fᵢ|0, I) represents a normal distribution with a mean of 0 and a covariance matrix being the identity matrix I, the identity matrix I is a matrix where the variance of each dimension is 1 and different dimensions are uncorrelated with each other, and ΠᵢN(fᵢ|0, I) represents the product of the normal distribution probability densities of all feature dimension data fᵢ.

In operation a4, a feature dimension dependency calculation is performed on the fourth representation vector and the fifth disentangled representation vector to obtain a feature dimension dependency.

The feature dimension dependency may be a loss value calculated through the following total correlation loss function L_{TC}:

$${L}_{TC} = KL ( P ( f \vert z ) \vert \vert {\prod }_{i} P ( {f}_{i} \vert z ) ) .$$

Where P(fᵢ|z) represents the actual feature dimension disentangled probability distribution of the feature dimension data fᵢ under the given fourth representation vector z, and ΠᵢN(fᵢ|0, I) represents the product of the actual feature dimension disentangled probability distributions of all feature dimension data fᵢ. Similar to the KL divergence loss function for the prior distribution, the total correlation loss function L_{TC} is used to quantify divergence between P(f|z) and ΠᵢN(fᵢ|0, I). That is to say, the total correlation loss function is used to reduce the mutual dependency between the fifth disentangled feature vector f and each feature dimension fᵢ.

In operation a5, the second loss value is determined based on the image pixel difference result, the image feature dimension difference processing result, the feature dimension disentangled probability distribution proximity and the feature dimension dependency.

The second loss value may specifically be a loss value calculated through the following second loss value function L (x, \hat{x}):

$$L ( x , \hat{x} ) = {λ}_{1} * {L}_{rec} + {λ}_{2} * {L}_{per} + {λ}_{3} * {L}_{KL} + {λ}_{4} * {L}_{TC} .$$

Where L_{rec}, Lₚₑᵣ, L_{KL} and L_{TC} are the reconstruction loss function, the perceptual loss function, the KL divergence loss function and the total correlation loss function in the aforementioned operations a1 to a4, respectively, λ₁, λ₂, λ₃ and λ₄ are weights corresponding to the reconstruction loss function L_{rec}, the perceptual loss function Lₚₑᵣ, the KL divergence loss function L_{KL} and the total correlation loss function L_{TC}, respectively. That is to say, the second loss value is obtained by weighting the loss values calculated in the aforementioned operations a1 to a4.

In a specific implementation, the values of weights λ₁, λ₂, λ₃ and λ₄ may be preset as needed, and at this time, the values of λ₁ and λ₂ may be the same or different from the values of λ₁ and λ₂ used for training the second sub-model and fourth sub-model.

In summary, when the model parameters of the second sub-model and the fourth sub-model are frozen, and the third sub-model and the fifth sub-model are added as the module to be learned to continue training by using the third face images, the second loss function used for calculating the second loss value may also be a weighted sum of both the reconstruction loss function and the perceptual loss function, and then the KL divergence loss function is introduced for the fifth disentangled representation vector to constrain the difference between the fifth disentangled representation vector and the prior distribution, and the total correlation (TC) loss function is added to reduce the mutual dependency between potential features. The trained third sub-model and fifth sub-model are capable of transforming the original representation vector (the fourth representation vector) of the facial expression image into a disentangled representation vector (such as the fifth disentangled representation vector).

As can be seen that, in the example, the second loss value is determined together based on the pixel-level difference at the low level, the semantic feature difference at the high-level, the feature dimension disentangled probability distribution proximity determined based on the original representation vector and the disentangled representation vector of the face image, and the feature dimension dependency determined based on the original representation vector and the disentangled representation vector of the face image, which is beneficial to improve the training effect of the second sub-model and the fourth sub-model.

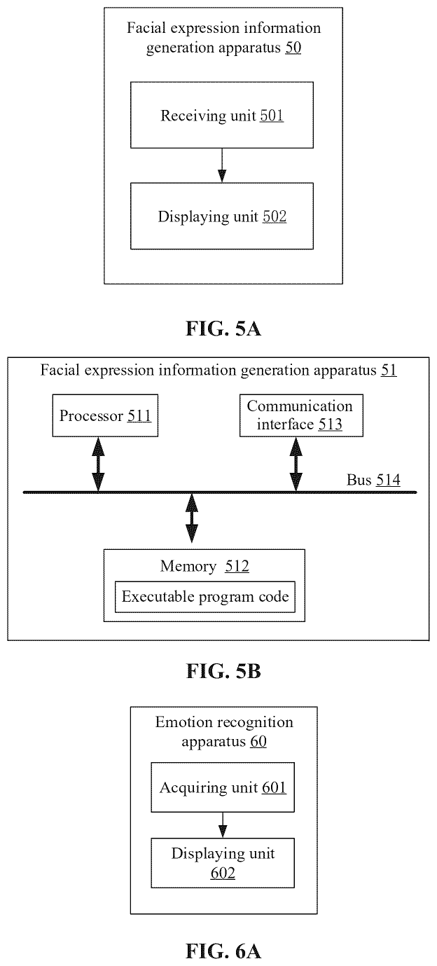

Referring to FIG. 5A, it is a schematic structural diagram of an apparatus for generating facial expression information according to an embodiment of the disclosure. The apparatus may be applied to the electronic device 101 as illustrated in FIG. 1, and as illustrated in FIG. 5A, the apparatus 50 for generating the facial expression information includes a receiving unit 501 and a displaying unit 502.

The receiving unit 501 is configured to receive a first parameter value of a first emotion. The first parameter value is used to represent an intensity of the first emotion.

The displaying unit 502 is configured to, when the first emotion is a first basic emotion, display first facial expression information adapted to the first parameter value of the first basic emotion.

In one possible example, the displaying unit 502 is further configured to: perform a first encoding on the first parameter value of the first basic emotion to obtain first feature dimension data, the first feature dimension data has a correlation with a facial expression; fuse the first feature dimension data and second feature dimension data to obtain a first disentangled representation vector, the second feature dimension data has no correlation with the facial expression; perform a data coupling transformation on the first disentangled representation vector to obtain a first representation vector; and perform a first decoding on the first representation vector to obtain the first facial expression information.

In one possible example, the apparatus 50 for generating the facial expression information is further configured to: before fusing the first feature dimension data and the second feature dimension data to obtain the first disentangled representation vector, create the second feature dimension data by randomly sampling a preset facial expression image; or acquire an original facial expression image, perform a second encoding and a data decoupling transformation on the original facial expression image to obtain a second disentangled representation vector, and extract the second feature dimension data that has no correlation with the facial expression in the second disentangled representation vector.

In one possible example, the apparatus 50 for generating the facial expression information is further configured to: before receiving the first parameter value of the first emotion, acquire an interaction operation for a component of an application interface; and acquire the first parameter value of the first emotion based on the interaction operation.

In one possible example, the component includes a numerical adjustment control for the first parameter value of the first basic emotion. The interaction operation is a numerical adjustment operation for the numerical adjustment control.

In one possible example, the component includes a first selection control for a first compound emotion, the application interface further displays a second selection control for a second compound emotion, and the second compound emotion is different from the first compound emotion. The interaction operation is a selection operation for the first selection control.

In one possible example, in terms of acquiring the first parameter value of the first emotion based on the interaction operation, the apparatus 50 for generating the facial expression information is specifically configured to: determine the first compound emotion based on the selection operation for the first selection control; and query first mapping relationship set by using the first compound emotion as a query identifier, and acquire a second basic emotion configuration corresponding to the first compound emotion. The second basic emotion configuration includes a second basic emotion and a second parameter value of the second basic emotion, and the mapping relationship set includes a correspondence between the first compound emotion and the second basic emotion configuration.

In one possible example, the apparatus 50 for generating the facial expression information is further configured to: before receiving the first parameter value of the first emotion, acquire voice information and/or image information of a user; and acquire the first parameter value of the first emotion based on the voice information and/or the image information.

In one possible example, the apparatus 50 for generating the facial expression information is further configured to: when the first emotion is a first compound emotion, perform a basic emotion analysis on the first parameter value of the first compound emotion to obtain a second parameter value of a second basic emotion; and display the first facial expression information adapted to the second parameter value of the second basic emotion.

It is worth pointing out that, the implementation of the specific functionality of the facial expression information generation apparatus 50 refers to the description of the facial expression information generation method illustrated in FIG. 2A above. For example, the receiving unit 501 is configured to implement the content related to the execution of the operation S201, and the displaying unit 502 is configured to implement the content related to the execution of the operation S202. The respective units or modules in the facial expression information generation apparatus 50 may be separately one or several additional units or modules or completely combined into one or several additional units or modules, or one or more of the units or modules may be further split into multiple functionally smaller units or modules, which may achieve the same operations without affecting the realization of the technical effects of the embodiments of the disclosure. The above units or modules are divided according to logical functions. In practical applications, the function of a unit (or module) is realized by multiple units (or modules), or the functions of multiple units (or modules) is realized by a unit (or module).

Based on the descriptions of the above method embodiment and the related device embodiment, and with reference to FIG. 5B, an embodiment of the disclosure also provides another apparatus for generating the facial expression information. As illustrated in FIG. 5B, the apparatus 51 for generating facial expression information includes a processor 511, a memory 512, a communication interface 513, and a bus 514. The processor 511, the memory 512, and the communication interface 513 are communicatively connected with each other through the bus 514.

Optionally, the memory 512 is a read-only memory (ROM), a static storage device, a dynamic storage device, or a random access memory (RAM).

The memory 512 may store executable program code, and when the executable program code stored in the memory 512 is executed by the processor 511, the processor 511 and the communication interface 513 are configured to perform respective operations in the method for generating the facial expression information according to the embodiment as illustrated in FIG. 2A.

The processor 511 adopts a general-purpose CPU, a microprocessor, an application-specific integrated circuit (ASIC), a GPU, or one or more integrated circuits for executing related programs to perform the method for generating the facial expression information according to the method embodiment of the disclosure.

The processor 511 may further be an integrated circuit chip with a signal processing capability. During implementation, the operations of the facial expression information generation method may be accomplished through an integrated logic circuit of the hardware in the processor 511 or the instructions in the form of software. Optionally, the processor 511 is a general purpose processor, a DSP, an ASIC, a FPGA or other programmable logic devices, a discrete gate or a transistor logic device, or a discrete hardware component. Various methods, operations and logic block diagrams disclosed in the embodiments of the disclosure may be implemented or performed by the processor. The general-purpose processor is a microprocessor, or any conventional processor or the like. The operations of the methods disclosed in the embodiments of the disclosure may be directly embodied to be executed and completed by a hardware decoding processor, or by a combination of hardware and software modules in the decoding processor. Optionally, the software module is located in a RAM, a flash memory, a ROM, a programmable ROM (PROM), or an electrically erasable programmable memory, a register, or a mature storage medium in the field. The storage medium is located in the memory 512, and the processor 511 reads the information in the memory 512, in combination with its hardware, to perform functions required by modules included in the facial expression information generation apparatus 50 or the facial expression information generation apparatus 51 in the embodiments of the disclosure, or perform the facial expression information generation method in the method embodiment of the disclosure.

The communication interface 513 uses a transceiver-related device, such as but not limited to a transceiver.

The bus 514 may include paths for communicating information between various components (e.g., the memory 512, the processor 511, and the communication interface 513) of the facial expression information generation apparatus 51.

It should be noted that although the facial expression information generation apparatus 51 illustrated in FIG. 5B merely illustrates a memory, a processor, and a communication interface, in the specific implementation, it should be understood by those skilled in the art that the facial expression information generation apparatus 51 also includes other devices required for realizing normal operation. Meanwhile, according to specific needs, it should be understood by those skilled in the art that the facial expression information generation apparatus 51 may also include hardware devices for implementing other additional functions. Furthermore, it should be understood by those skilled in the art that the facial expression information generation apparatus 51 may also include merely the devices required for implementing the embodiments of the disclosure, and does not necessarily include all the devices illustrated in FIG. 5B.

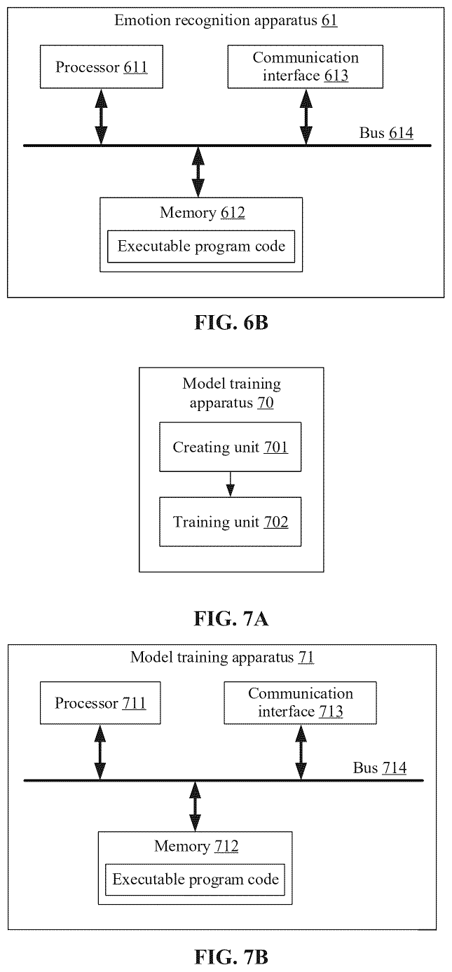

Referring to FIG. 6A, it is a schematic structural diagram of an apparatus for recognizing an emotion according to an embodiment of the disclosure. The apparatus may be applied to the electronic device 101 as illustrated in FIG. 1, and as illustrated in FIG. 6A, the apparatus 60 for recognizing the emotion includes an acquiring unit 601 and a displaying unit 602.

The acquiring unit 601 is configured to acquire a second facial expression image.

The displaying unit 602 is configured to display a second emotion adapted to the second facial expression image and a third parameter value of the second emotion. When the second emotion is a third basic emotion, the third parameter value is used to represent an intensity of the third basic emotion.

In one possible example, the displaying unit 602 is specifically configured to: perform a third encoding on the second facial expression image to obtain a third representation vector; perform a data decoupling transformation on the third representation vector to obtain a third disentangled representation vector; extract third feature dimension data, that has a correlation with a facial expression, in the third disentangled representation vector; and perform a third decoding on the third feature dimension data to obtain the second emotion and the third parameter value of the second emotion.

It is worth pointing out that, for the specific implementation of the functionality of the emotion recognition apparatus 60 refers to the description of the emotion recognition method illustrated in FIG. 3A above. For example, the acquiring unit 601 is configured to implement the content related to the execution of the operation S301, and the displaying unit 602 is configured to implement the content related to the execution of the operation S302. The respective units or modules in the emotion recognition apparatus 60 may be separately one or several additional units or modules or completely combined into one or several additional units or modules, or one or more of the units or modules may be further split into multiple functionally smaller units or modules, which may achieve the same operations without affecting the realization of the technical effects of the embodiments of the disclosure. The above units or modules are divided according to logical functions. In practical applications, the function of a unit (or module) is realized by multiple units (or modules), or the functions of multiple units (or modules) is realized by a unit (or module).

Based on the descriptions of the above method embodiment and the related device embodiment, and with reference to FIG. 6B, an embodiment of the disclosure also provides another apparatus 61 for recognizing an emotion. As illustrated in FIG. 6B, the apparatus 61 for recognizing the emotion includes a processor 611, a memory 612, a communication interface 613, and a bus 614. The processor 611, the memory 612, and the communication interface 613 are communicatively connected with each other through the bus 614.

In an embodiment, the memory 612 is a ROM, a static storage device, a dynamic storage device, or a RAM.

The memory 612 may store executable program code, and when the executable program code stored in the memory 612 is executed by the processor 611, the processor 611 and the communication interface 613 are configured to perform respective operations in the method for recognizing the emotion according to the embodiment as illustrated in FIG. 3A.

The processor 611 adopts a general-purpose CPU, a microprocessor, an ASIC, a GPU, or one or more integrated circuits for executing related programs to perform the method for recognizing the emotion according to the method embodiment of the disclosure.

The processor 611 may further be an integrated circuit chip with a signal processing capability. During implementation, the operations of the emotion recognition method may be accomplished through an integrated logic circuit of the hardware in the processor 611 or the instructions in the form of software. Optionally, the processor 611 is a general purpose processor, a DSP, an ASIC, a FPGA or other programmable logic devices, a discrete gate or a transistor logic device, or a discrete hardware component. Various methods, operations and logic block diagrams disclosed in the embodiments of the disclosure may be implemented or performed by the processor. The general-purpose processor is a microprocessor, or any conventional processor or the like. The operations of the methods disclosed in the embodiments of the disclosure may be directly embodied to be executed and completed by a hardware decoding processor, or by a combination of hardware and software modules in the decoding processor. Optionally, the software module is located in a RAM, a flash memory, a ROM, a PROM, or an electrically erasable programmable memory, a register, or a mature storage medium in the field. The storage medium is located in the memory 612, and the processor 611 reads the information in the memory 612, in combination with its hardware, to perform functions required by modules included in the emotion recognition apparatus 61 in the embodiment of the disclosure, or perform the emotion recognition method in the method embodiment of the disclosure.

The communication interface 613 uses a transceiver-related device, such as but not limited to a transceiver.

The bus 614 may include paths for communicating information between various components (e.g., the memory 612, the processor 611, and the communication interface 613) of the emotion recognition apparatus 61.

It should be noted that although the emotion recognition apparatus 61 illustrated in FIG. 6B merely illustrates a memory, a processor, and a communication interface, in the specific implementation, it should be understood by those skilled in the art that the apparatus 61 for recognizing the emotion also includes other devices required for realizing normal operation. Meanwhile, according to specific needs, it should be understood by those skilled in the art that the apparatus 61 for recognizing the emotion may also include hardware devices for implementing other additional functions. Furthermore, it should be understood by those skilled in the art that the apparatus 61 for recognizing the emotion may also include merely the devices required for implementing the embodiments of the disclosure, and does not necessarily include all the devices illustrated in FIG. 6B.

Referring to FIG. 7A, it is a schematic structural diagram of an apparatus for training a model according to an embodiment of the disclosure. The apparatus may be applied to the electronic device 101 as illustrated in FIG. 1, and as illustrated in FIG. 7A, the apparatus 70 for training the model includes a creating unit 701 and a training unit 702.

The creating unit 701 is configured to create a first training set. The first training set includes fourth feature dimension data and a fourth parameter value of a fourth basic emotion, the fourth feature dimension data has a correlation with a facial expression, and the fourth parameter value is used to represent an intensity of the fourth basic emotion.

The training unit 702 is configured to train a first sub-model of a first model with the fourth feature dimension data and the fourth parameter value of the fourth basic emotion.

In one possible example, the creating unit 701 is specifically configured to: acquire a first face image set, a first face image in the first face image set includes a fifth parameter value of a fifth basic emotion; perform a fourth encoding on the first face image to obtain a second representation vector; perform a data decoupling transformation on the second representation vector to obtain a third disentangled representation vector; extract the fourth feature dimension data, that has the correlation with the facial expression, in the third disentangled representation vector; process the fifth parameter value of the fifth basic emotion by adopting a label softening technique to obtain the fourth parameter value of the fourth basic emotion; and create the first training set based on the fourth feature dimension data and the fourth parameter value of the fourth basic emotion.

In one possible example, the apparatus 70 for training the model is further configured to: create a second face image set, the second face image set includes multiple second face images with different facial expressions; perform a fifth encoding on each of the multiple second face images to obtain multiple third representation vectors; perform a data decoupling transformation on the multiple third representation vectors to obtain multiple fourth disentangled representation vectors; and perform a facial expression correlation analysis on each of the multiple fourth disentangled representation vectors to obtain the correlation between the fourth feature dimension data and the facial expression.

In one possible example, in terms of performing the fifth encoding on each of the multiple second face images to obtain the multiple third representation vectors, the apparatus 70 for training the model is specifically configured to: perform the fifth encoding on each of the multiple second face images by calling a second sub-model of the first model to obtain the multiple third representation vectors; perform the data decoupling transformation on the multiple third representation vectors by calling a third sub-model of the first model to obtain the multiple fourth disentangled representation vectors; creating third face image set, and the third face image set includes third face images; training the second sub-model of the first model and a fourth sub-model of the first model based on the third face images; and training the third sub-model of the first model and a fifth sub-model of the first model based on the third face images.

In one possible example, in terms of training the second sub-model of the first model and the fourth sub-model of the first model based on the third face images, the apparatus 70 for training the model is specifically configured to: perform a first prediction processing on each of the third face images based on the second sub-model and the fourth sub-model to obtain a first prediction face image; perform a first loss calculation on the third face image and the first prediction face image based on a first loss function to obtain a first loss value; perform a first gradient calculation on model parameters of the second sub-model and the fourth sub-model based on the first loss value and the first loss function to obtain a first gradient value; and adjust the model parameters of the second sub-model and the fourth sub-model based on the first gradient value to obtain the second sub-model and the fourth sub-model.

In one possible example, in terms of performing the first loss calculation on the third face image and the first prediction face image based on the first loss function to obtain the first loss value, the apparatus 70 for training the model is specifically configured to: perform an image pixel difference processing on the third face image and the first prediction face image to obtain an image pixel difference result; perform an image feature dimension difference processing on the third face image and the first prediction face image to obtain an image feature dimension difference processing result; and determine the first loss value based on the image pixel difference result and the image feature dimension difference processing result.

In one possible example, in terms of training the third sub-model of the first model and the fifth sub-model of the first model based on the third face images, the apparatus 70 for training the model is specifically configured to: perform a second prediction processing on each of the third face images based on the second sub-model, the third sub-model, the fourth sub-model and the fifth sub-model to obtain a second prediction face image; perform a sixth encoding on the third face images by calling the second sub-model to obtain multiple fourth representation vectors; perform a data decoupling transformation on each of the multiple fourth representation vectors by calling the third sub-model to obtain a fifth disentangled representation vector; perform a second loss calculation on the third face image, the fourth representation vector, the fifth disentangled representation vector and the second prediction face image based on a second loss function to obtain a second loss value; perform a second gradient calculation on model parameters of the third sub-model and the fifth sub-model based on the second loss value and the second loss function to obtain a second gradient value; and adjust the model parameters of the third sub-model and the fifth sub-model based on the second gradient value to obtain the third sub-model and the fifth sub-model.

In one possible example, in terms of performing the second loss calculation on the third face image, the fourth representation vector, the fifth disentangled representation vector and the second prediction face image based on the second loss function to obtain the second loss value, the apparatus 70 for training the model is specifically configured to: perform an image pixel difference processing on the third face image and the second prediction face image to obtain an image pixel difference result; perform an image feature dimension difference processing on the third face image and the second prediction face image to obtain an image feature dimension difference processing result; perform a feature dimension disentangled probability distribution proximity calculation on the fourth representation vector and the fifth disentangled representation vector to obtain a feature dimension disentangled probability distribution proximity; perform a feature dimension dependency calculation on the fourth representation vector and the fifth disentangled representation vector to obtain a feature dimension dependency; and determine the second loss value based on the image pixel difference result, the image feature dimension difference processing result, the feature dimension disentangled probability distribution proximity and the feature dimension dependency.

It is worth pointing out that, for the specific implementation of the functionality of the model training apparatus 70 refers to the description of the model training method illustrated in FIG. 4A above. For example, the creating unit 701 is configured to implement the content related to the execution of the operation S401, and the training unit 702 is configured to implement the content related to the execution of the operation S402. The respective units or modules in the model training apparatus 70 may be separately one or several additional units or modules or completely combined into one or several additional units or modules, or one or more of the units or modules may be further split into multiple functionally smaller units or modules, which may achieve the same operations without affecting the realization of the technical effects of the embodiments of the disclosure. The above units or modules are divided according to logical functions. In practical applications, the function of a unit (or module) is realized by multiple units (or modules), or the functions of multiple units (or modules) is realized by a unit (or module).

Based on the descriptions of the above method embodiment and the related device embodiment, and with reference to FIG. 7B, an embodiment of the disclosure also provides another apparatus 71 for training a model. As illustrated in FIG. 7B, the apparatus 71 for training the model includes a processor 711, a memory 712, a communication interface 713, and a bus 714. The processor 711, the memory 712, and the communication interface 713 are communicatively connected with each other through the bus 714.

Optionally, the memory 712 is a ROM, a static storage device, a dynamic storage device, or a RAM.

The memory 712 may store executable program code, and when the executable program code stored in the memory 712 is executed by the processor 711, the processor 711 and the communication interface 713 are configured to perform respective operations in the method for training the model according to the embodiment as illustrated in FIG. 4A.

The processor 711 adopts a general-purpose CPU, a microprocessor, an ASIC, a GPU, or one or more integrated circuits for executing related programs to perform the method for training the model according to the method embodiment of the disclosure.

The processor 711 may further be an integrated circuit chip with a signal processing capability. During implementation, the operations of the model training method may be accomplished through an integrated logic circuit of the hardware in the processor 711 or the instructions in the form of software. Optionally, the processor 711 is a general purpose processor, a DSP, an ASIC, a FPGA or other programmable logic devices, a discrete gate or a transistor logic device, or a discrete hardware component. Various methods, operations and logic block diagrams disclosed in the embodiments of the disclosure may be implemented or performed by the processor. The general-purpose processor is a microprocessor, or any conventional processor or the like. The operations of the methods disclosed in the embodiments of the disclosure may be directly embodied to be executed and completed by a hardware decoding processor, or by a combination of hardware and software modules in the decoding processor. Optionally, the software module is located in a RAM, a flash memory, a ROM, a PROM, or an electrically erasable programmable memory, a register, or a mature storage medium in the field. The storage medium is located in the memory 712, and the processor 711 reads the information in the memory 712, in combination with its hardware, to perform functions required by modules included in the model training apparatus 71 in the embodiment of the disclosure, or perform the model training method in the method embodiment of the disclosure.

The communication interface 713 uses a transceiver-related device, such as but not limited to a transceiver.

The bus 714 may include paths for communicating information between various components (e.g., the memory 712, the processor 711, and the communication interface 713) of the model training apparatus 71.

It should be noted that although the model training apparatus 71 illustrated in FIG. 7B merely illustrates a memory, a processor, and a communication interface, in the specific implementation, it should be understood by those skilled in the art that the apparatus 71 for training the model also includes other devices required for realizing normal operation. Meanwhile, according to specific needs, it should be understood by those skilled in the art that the apparatus 71 for training the model may also include hardware devices for implementing other additional functions. Furthermore, it should be understood by those skilled in the art that the apparatus 71 for training the model may also include merely the devices required for implementing the embodiments of the disclosure, and does not necessarily include all the devices illustrated in FIG. 7B.

In the embodiment of the disclosure, a computer-readable storage medium having stored thereon the executable program code is provided. The executable program code includes executable instructions, the executable instructions are configured to perform some or all of the operations in any of the method for generating the facial expression information, the method for recognizing the emotion, or the method for training the model as described in the above embodiments, and the above computer includes an electronic device or a server.

In the embodiment of the disclosure, a computer program product is provided. The computer program product includes a computer program, the computer program is configured to cause a computer to perform some or all of the operations in any of the method for generating the facial expression information, the method for recognizing the emotion, or the method for training the model as described in the above embodiments, and the computer program product may be a software installation package.

It should be noted that, for any of the above embodiments of the method for generating the facial expression information, the method for recognizing the emotion, and the method for training the model, they are described as a series of action combinations for the sake of simplicity. However, it should be understood by those skilled in the art that the disclosure is not limited by the described sequence of actions. This is because, according to the disclosure, some operations may be performed in other sequences or simultaneously. Secondly, it should also be understood by those skilled in the art that the embodiments described in the description are preferred embodiments, and the involved actions are not necessarily required for the disclosure.

Embodiments of the disclosure are described in detail above. Herein, the specific examples are used to explain the principles and implementations of the method and apparatus for generating the facial expression information, the method and apparatus for recognizing the emotion, and the method and apparatus for training the model in the disclosure. The description of the above embodiments is only used to help understand the methods and core ideas of the disclosure. At the same time, for those of ordinary skilled in the art, according to the ideas of the method and apparatus for generating the facial expression information, the method and apparatus for recognizing the emotion, and the method and apparatus for training the model in the disclosure, there will be changes in detail implementations and application scope. In summary, the content in this description should not be construed as a limitation of the disclosure.

The disclosure is described with reference to flowcharts and/or block diagrams of a method, a hardware product, and a computer program product according to embodiments of the disclosure. It should be understood that each flow in the flowcharts and/or each block in the block diagrams, as well as combinations of flows in the flowcharts and/or blocks in the block diagrams, may be implemented through computer program instructions. These computer program instructions may be provided to a general purpose computer, a special purpose computer, an embedded processor, or a processor of other programmable data processing apparatus to generate a machine, such that the instructions executed by the computer or the processor of other programmable data processing apparatus generate an apparatus for implementing the functions specified in one or more flows in the flowcharts or one or more blocks in the block diagrams.

These computer program instructions may also be stored in a computer-readable memory capable of directing a computer or other programmable data processing apparatus to operate in a particular manner, such that the instructions stored in the computer-readable memory generate an article of manufacture containing an instruction device that implement the functions specified in one or more flows in the flowcharts or one or more blocks in the block diagrams. The memory may include a flash disk, a ROM, a RAM, a magnetic disk or an optical disk, and the like.

Although the disclosure has been described herein in connection with various embodiments, during implementing the claimed disclosure, those of skilled in the art may understand and implement other variations of the disclosed embodiments by reviewing the drawings, the description, and the accompanying claims. In the claims, the word “comprising” does not exclude the presence of other components or operations, and “a” or “an” does not exclude the possibility of multiple. Certain operations are recited in mutually different dependent claims, but this does not mean that these operations cannot be combined to produce good effects.

It is to be understood by those of ordinary skilled in the art that all or some of the operations in various methods of the method embodiments of any of the above facial expression information generation method may be implemented by instructing related hardware through a program, the program may be stored in a computer-readable memory, and the memory may include a flash disk, a ROM, a RAM, a magnetic disk or an optical disk, and the like.

It is to be understood that, any product that is controlled or configured to perform the processing method described in the flowchart of the method embodiment for generating the facial expression information in the disclosure, such as the apparatus and the computer program product of the above flowcharts, falls within the scope of related products described in the disclosure.

It is apparent that those skilled in the art may make various modifications and variations to the method and apparatus for generating the facial expression information, the method and apparatus for recognizing the emotion, and the method and apparatus for training the model in the disclosure without departing from the spirit and scope of the disclosure. Thus, if such modifications and variations of the disclosure fall within the scope of the claims of the disclosure and their equivalents, the disclosure also intends to include such modifications and variations.

1. A method for generating facial expression information, performed by an electronic device, comprising:
receiving a first parameter value of a first emotion, wherein the first parameter value is used to represent an intensity of the first emotion; and
when the first emotion is a first basic emotion, displaying first facial expression information adapted to the first parameter value of the first basic emotion.

2. The method of claim 1, wherein displaying the first facial expression information adapted to the first parameter value of the first basic emotion comprises:
performing a first encoding on the first parameter value of the first basic emotion to obtain first feature dimension data, wherein the first feature dimension data has a correlation with a facial expression;
fusing the first feature dimension data and second feature dimension data to obtain a first disentangled representation vector, wherein the second feature dimension data has no correlation with the facial expression;
performing a data coupling transformation on the first disentangled representation vector to obtain a first representation vector; and
performing a first decoding on the first representation vector to obtain the first facial expression information.

3. The method of claim 2, wherein before fusing the first feature dimension data and the second feature dimension data to obtain the first disentangled representation vector, the method further comprises:
creating the second feature dimension data by randomly sampling a preset facial expression image; or
acquiring an original facial expression image; performing a second encoding and a data decoupling transformation on the original facial expression image to obtain a second disentangled representation vector; and extracting, in the second disentangled representation vector, the second feature dimension data that has no correlation with the facial expression.

4. The method of claim 1, wherein before receiving the first parameter value of the first emotion, the method further comprises:
acquiring an interaction operation for a component of an application interface; and
acquiring the first parameter value of the first emotion based on the interaction operation.

5. The method of claim 4, wherein the component comprises a numerical adjustment control for the first parameter value of the first basic emotion; and
the interaction operation is a numerical adjustment operation for the numerical adjustment control.

6. The method of claim 4, wherein the component comprises a first selection control for a first compound emotion, the application interface further displays a second selection control for a second compound emotion, and the second compound emotion is different from the first compound emotion; and
the interaction operation is a selection operation for the first selection control;
wherein acquiring the first parameter value of the first emotion based on the interaction operation comprises:
determining the first compound emotion based on the selection operation for the first selection control; and
querying a first mapping relationship set by using the first compound emotion as a query identifier, and acquiring a second basic emotion configuration corresponding to the first compound emotion, wherein the second basic emotion configuration comprises a second basic emotion and a second parameter value of the second basic emotion, and the first mapping relationship set comprises a correspondence between the first compound emotion and the second basic emotion configuration.

7. The method of claim 1, wherein before receiving the first parameter value of the first emotion, the method further comprises:
acquiring at least one of voice information or image information of a user; and
acquiring the first parameter value of the first emotion based on the at least one of the voice information or the image information;
wherein the method further comprises:
when the first emotion is a first compound emotion, performing a basic emotion analysis on the first parameter value of the first compound emotion to obtain a second parameter value of a second basic emotion; and
displaying the first facial expression information adapted to the second parameter value of the second basic emotion.

8. A method for recognizing an emotion, performed by an electronic device, comprising:
acquiring a second facial expression image; and
displaying a second emotion adapted to the second facial expression image and a third parameter value of the second emotion, wherein when the second emotion is a third basic emotion, the third parameter value is used to represent an intensity of the third basic emotion.

9. The method of claim 8, wherein displaying the second emotion adapted to the second facial expression image and the third parameter value of the second emotion comprises:
performing a third encoding on the second facial expression image to obtain a third representation vector;
performing a data decoupling transformation on the third representation vector to obtain a third disentangled representation vector;
extracting third feature dimension data, that has a correlation with a facial expression, in the third disentangled representation vector; and
performing a third decoding on the third feature dimension data to obtain the second emotion and the third parameter value of the second emotion.

10. A method for training a model, performed by an electronic device, comprising:
creating a first training set, wherein the first training set comprises fourth feature dimension data and a fourth parameter value of a fourth basic emotion, the fourth feature dimension data has a correlation with a facial expression, and the fourth parameter value is used to represent an intensity of the fourth basic emotion; and
training a first sub-model of a first model with the fourth feature dimension data and the fourth parameter value of the fourth basic emotion.

11. The method of claim 10, wherein creating the first training set comprises:
acquiring a first face image set, wherein a first face image in the first face image set comprises a fifth parameter value of a fifth basic emotion;
performing a fourth encoding on the first face image to obtain a second representation vector;
performing a data decoupling transformation on the second representation vector to obtain a third disentangled representation vector;
extracting the fourth feature dimension data, that has the correlation with the facial expression, in the third disentangled representation vector;
processing the fifth parameter value of the fifth basic emotion by adopting a label softening technique to obtain the fourth parameter value of the fourth basic emotion; and
creating the first training set based on the fourth feature dimension data and the fourth parameter value of the fourth basic emotion.

12. The method of claim 11, wherein the method further comprises:
creating a second face image set, wherein the second face image set comprises a plurality of second face images with different facial expressions;
performing a fifth encoding on each of the plurality of second face images to obtain a plurality of third representation vectors;
performing a data decoupling transformation on the plurality of third representation vectors to obtain a plurality of fourth disentangled representation vectors; and
performing a facial expression correlation analysis on each of the plurality of fourth disentangled representation vectors to obtain the correlation between the fourth feature dimension data and the facial expression.

13. The method of claim 12, wherein
performing the fifth encoding on each of the plurality of second face images to obtain the plurality of third representation vectors comprises: performing the fifth encoding on each of the plurality of second face images by calling a second sub-model of the first model to obtain the plurality of third representation vectors;
performing the data decoupling transformation on the plurality of third representation vectors to obtain the plurality of fourth disentangled representation vectors comprises: performing the data decoupling transformation on the plurality of third representation vectors by calling a third sub-model of the first model to obtain the plurality of fourth disentangled representation vectors;
and the method further comprises:
creating a third face image set, wherein the third face image set comprises third face images;
training the second sub-model of the first model and a fourth sub-model of the first model based on the third face images; and
training the third sub-model of the first model and a fifth sub-model of the first model based on the third face images.

14. The method of claim 13, wherein training the second sub-model of the first model and the fourth sub-model of the first model based on the third face images comprises:
performing a first prediction processing on each of the third face images based on the second sub-model and the fourth sub-model to obtain a first prediction face image;
performing a first loss calculation on the third face image and the first prediction face image based on a first loss function to obtain a first loss value;
performing a first gradient calculation on model parameters of the second sub-model and the fourth sub-model based on the first loss value and the first loss function to obtain a first gradient value; and
adjusting the model parameters of the second sub-model and the fourth sub-model based on the first gradient value to obtain the second sub-model and the fourth sub-model.

15. The method of claim 14, wherein performing the first loss calculation on the third face image and the first prediction face image based on the first loss function to obtain the first loss value comprises:
performing an image pixel difference processing on the third face image and the first prediction face image to obtain an image pixel difference result;
performing an image feature dimension difference processing on the third face image and the first prediction face image to obtain an image feature dimension difference processing result; and
determining the first loss value based on the image pixel difference result and the image feature dimension difference processing result.

16. The method of claim 13, wherein training the third sub-model of the first model and the fifth sub-model of the first model based on the third face images comprises:
performing a second prediction processing on each of the third face images based on the second sub-model, the third sub-model, the fourth sub-model and the fifth sub-model to obtain a second prediction face image;
performing a sixth encoding on the third face images by calling the second sub-model to obtain a plurality of fourth representation vectors;
performing a data decoupling transformation on each of the plurality of fourth representation vectors by calling the third sub-model to obtain a fifth disentangled representation vector;
performing a second loss calculation on the third face image, the fourth representation vector, the fifth disentangled representation vector and the second prediction face image based on a second loss function to obtain a second loss value;
performing a second gradient calculation on model parameters of the third sub-model and the fifth sub-model based on the second loss value and the second loss function to obtain a second gradient value; and
adjusting the model parameters of the third sub-model and the fifth sub-model based on the second gradient value to obtain the third sub-model and the fifth sub-model.

17. The method of claim 16, wherein performing the second loss calculation on the third face image, the fourth representation vector, the fifth disentangled representation vector and the second prediction face image based on the second loss function to obtain the second loss value comprises:
performing an image pixel difference processing on the third face image and the second prediction face image to obtain an image pixel difference result;
performing an image feature dimension difference processing on the third face image and the second prediction face image to obtain an image feature dimension difference processing result;
performing a feature dimension disentangled probability distribution proximity calculation on the fourth representation vector and the fifth disentangled representation vector to obtain a feature dimension disentangled probability distribution proximity;
performing a feature dimension dependency calculation on the fourth representation vector and the fifth disentangled representation vector to obtain a feature dimension dependency; and
determining the second loss value based on the image pixel difference result, the image feature dimension difference processing result, the feature dimension disentangled probability distribution proximity and the feature dimension dependency.

18. An apparatus for generating facial expression information, comprising a processor and a memory configured to store a computer program runnable on the processor, wherein the processor is configured to perform the method of claim 1.

19. An apparatus for recognizing an emotion, comprising a processor and a memory configured to store a computer program runnable on the processor, wherein the processor is configured to perform the method of claim 8.

20. An apparatus for training a model, comprising a processor and a memory configured to store a computer program runnable on the processor, wherein the processor is configured to perform the method of claim 10.
